(19) United States
(12) Patent Application Publication
(10) Pub. No.: US 2013/0279526 A1
(43) Pub. Date: Oct. 24, 2013

(54) LASER APPARATUS

(71) Applicant: GIGAPHOTON INC., Tochigi (JP)

(72) Inventors: Kouji KAKIZAKI, Tochigi (JP); Takashi Onose, Tochigi (JP); Shinji Ito, Tochigi (JP)

(73) Assignee: Gigaphoton Inc., Tochigi (JP)

(21) Appl. No.: 13/863,472

(22) Filed: Apr. 16, 2013

(30) Foreign Application Priority Data
Apr. 19, 2012 (JP) 2012-095427

(51) Int. Cl. H01S 3/10; H01S 3/083; H01S 3/08

(52) U.S. Cl. CPC H01S 3/10; H01S 3/08; H01S 3/083
USPC 372/5; 372/98; 372/94

(57) ABSTRACT

A laser apparatus may include a first laser light source configured to emit light with a first wavelength, a second laser light source including a titanium-sapphire laser device and a plurality of wavelength conversion elements and being configured to emit light with a second wavelength being one-fourth of a wavelength of light emitted from the titanium-sapphire laser device, and a wavelength conversion element configured in such a manner that the light with the first wavelength and the light with the second wavelength are incident thereon to emit light with a wavelength of about 193 nm corresponding to a sub frequency of the light with the first wavelength and the light with the second wavelength.

### CROSS-REFERENCE TO A RELATED APPLICATION(S)

The present application claims priority from Japanese Patent Application No. 2012-095427 filed Apr. 19, 2012, the entire contents of which are hereby incorporated by reference.

### BACKGROUND

1. Technical Field

The present disclosure relates to a laser apparatus.

2. Related Art

For typical excimer laser devices that are used as light sources for ultraviolet rays to be used for semiconductor lithography processes, KrF excimer laser devices for a wavelength of about 248 nm, ArF excimer laser devices for a wavelength of about 193 nm, and the like, have been present.

Most of such ArF excimer laser devices are being supplied in the market as two-stage laser systems including an oscillation stage laser device and an amplification stage laser device. The main structure common to the oscillation stage laser device and the amplification stage laser device of the two-stage ArF excimer laser system will be described. The oscillation stage laser device includes a first chamber and the amplification stage laser device includes a second chamber. A laser gas (a gas mixture of F₂, Ar, Ne, and Xe) is enclosed in each of the first and second chambers. Each of the oscillation stage laser device and the amplification stage laser device also includes an electric power supply for supplying electric energy to excite the laser gas. While each of the oscillation stage laser device and the amplification stage laser device can include the electric power supply, one electric power supply can also be shared thereby. First discharge electrodes, including a first anode and a first cathode that are each connected to the electric power supply, are installed in the first chamber, while second discharge electrodes, including a second anode and a second cathode that are each connected to the electric power supply, are installed in the second chamber as well.

A component specific to the oscillation stage laser device is, for example, a line narrowing module. The line narrowing module typically includes one grating and at least one prism beam expander. A semi-transmissive mirror and the grating constitute an optical resonator and the first chamber of the oscillation stage laser device is installed between the semi-transmissive mirror and the grating.

When electric discharge occurs between the first anode and the first cathode, which serve as the first discharge electrodes, the laser gas is excited and energy of the excitation is released so as to generate light. From the light, laser light with a selected wavelength is provided through the line narrowing module and outputted from the oscillation stage laser device.

Whereas the two-stage laser system in the case where the amplification stage laser device is a laser device including a resonator structure is referred to as a “master oscillator power oscillator (MOPO)”, the two-stage laser system in the case where the amplification stage laser device does not include a resonator structure and is not a laser device is referred to as a “master oscillator power amplifier (MOPA)”. When laser light from the oscillation stage laser device is present in the second chamber of the amplification stage laser device, a control is conducted to cause electric discharge between the second anode and the second cathode, which serve as the second discharge electrodes. Thereby, the laser gas in the second chamber is excited and laser light is amplified in and outputted from the amplification stage laser device.

### SUMMARY

A laser apparatus according to one aspect of the present disclosure may include a first laser light source, a second laser light source, and another wavelength conversion element. The first laser light source may be configured to emit light with a first wavelength. The second laser light source may include a titanium-sapphire laser device and a plurality of wavelength conversion elements and be configured to emit light with a second wavelength being one-fourth of a wavelength of light emitted from the titanium-sapphire laser device. The other wavelength conversion element may be configured in such a manner that the light with a first wavelength and the light with a second wavelength are incident thereon to emit light with a wavelength of about 193 nm corresponding to a sum frequency of the light with a first wavelength and the light with a second wavelength.

A laser apparatus according to another aspect of the present disclosure may include a first laser light source, a second laser light source, and a wavelength conversion unit. The first laser light source may include a fiber laser amplifier configured to emit light with a first wavelength. The second laser light source may include a fiber laser amplifier configured to emit light with a second wavelength. The wavelength conversion unit may include a plurality of wavelength conversion elements and be configured in such a manner that the light with a first wavelength and the light with a second wavelength are incident thereon to emit light with a wavelength of about 193 nm corresponding to a sum frequency of light with a wavelength being one-fourth of the first wavelength and light with a wavelength being one-half of the second wavelength.

A laser apparatus according to another aspect of the present disclosure may include a laser light source, and a wavelength conversion unit. The laser light source may include a fiber laser amplifier. The wavelength conversion unit may include a plurality of wavelength conversion elements and be configured in such a manner that light emitted from the laser light source is incident thereon to emit light with a wavelength of about 193 nm being one-sixth of a wavelength of light emitted from the laser light source.

A laser apparatus according to another aspect of the present disclosure may include a first laser light source, a second laser light source, and another wavelength conversion element. The first laser light source may be configured to emit light with a first wavelength. The second laser light source may include a titanium-sapphire laser device and a plurality of wavelength conversion elements and be configured to emit light with a second wavelength being one-third of a wavelength of light emitted from the titanium-sapphire laser device. The other wavelength conversion element may be configured in such a manner that the light with a first wavelength and the light with a second wavelength are incident thereon to emit light with a wavelength of about 193 nm corresponding to a sum frequency of the light with a first wavelength and the light with a second wavelength.

A laser apparatus according to another aspect of the present disclosure may include a resonator, and a master oscillator. The resonator may include a Fabry-Perot resonator and a cavity length L. The master oscillator may be configured in such a manner that light with a wavelength of about 193 nm and a pulse width τ₀ is incident on the resonator, wherein τ₀/T_{cavity}>0.27 in a case where T_{cavity}=2 nL/C (n: refractive index, C: velocity of light).

A laser apparatus according to another aspect of the present disclosure may include a resonator, and a master oscillator. The resonator may include a ring resonator with an optical path length L of a circuit of the ring resonator. The master oscillator may be configured in such a manner that light with a wavelength of about 193 nm and a pulse width τ₀ is incident on the resonator, wherein τ₀/T_{cavity}>0.27 in a case where T_{cavity}=nL/C (n: refractive index, C: velocity of light).

### BRIEF DESCRIPTION OF THE DRAWINGS

Hereinafter, selected embodiments of the present disclosure will be described with reference to the accompanying drawings.

FIG. 1 is a structural diagram of a laser apparatus of the present disclosure.

FIG. 2 is a structural diagram of a solid-state light source of a laser apparatus, according to a first embodiment of the present disclosure.

FIG. 3 is a diagram illustrating a solid-state light source of a laser apparatus, according to a first embodiment of the present disclosure.

FIG. 4 is a structural diagram of a titanium-sapphire laser device used in a laser apparatus of the present disclosure.

FIG. 5 is a structural diagram of another titanium-sapphire laser device used in a laser apparatus of the present disclosure.

FIG. 6 is a structural diagram of a first laser light source unit used in a laser apparatus of the present disclosure.

FIG. 7 is a structural diagram of a solid-state light source of a laser apparatus, according to a second embodiment of the present disclosure.

FIG. 8 is a diagram illustrating a solid-state light source of a laser apparatus, according to a second embodiment of the present disclosure.

FIG. 9 is a structural diagram of a solid-state light source of a laser apparatus, according to a third embodiment of the present disclosure.

FIG. 10 is a structural diagram of a solid-state light source of a laser apparatus, according to a fourth embodiment of the present disclosure.

FIG. 11 is a structural diagram of a solid-state light source of a laser apparatus, according to a fifth embodiment of the present disclosure.

FIG. 12 is a diagram illustrating a solid-state light source of a laser apparatus, according to a fifth embodiment of the present disclosure.

FIG. 13 is a diagram (1) illustrating the beam profile of laser light to be injected from an injection optical system.

FIG. 14 is a diagram (2) illustrating the beam profile of laser light to be injected from an injection optical system.

FIG. 15 is a diagram (1) illustrating the pulse width of laser light to be injected from an injection optical system.

FIG. 16 is a diagram (2) illustrating the pulse width of laser light to be injected from an injection optical system.

FIG. 17 is a diagram (3) illustrating the pulse width of laser light to be injected from an injection optical system.

FIG. 18 is a diagram (4) illustrating the pulse width of laser light to be injected from an injection optical system.

FIG. 19 is a diagram illustrating the intensity distribution of an output of laser light in the case of τ₀/T_{cavity}=0.18.

FIG. 20 is a diagram illustrating the intensity distribution of an output of laser light in the case of τ₀/T_{cavity}=0.27.

FIG. 21 is a diagram illustrating the intensity distribution of an output of laser light in the case of τ₀/T_{cavity}=0.5.

FIG. 22 is a diagram illustrating the correlation between τ₀/T_{cavity} and the peak intensity of the output.

FIG. 23 is a structural diagram of a solid-state light source capable of adjusting the pulse width of laser light to be injected.

FIG. 24 is a diagram illustrating a solid-state light source capable of adjusting the pulse width of laser light to be injected.

### DETAILED DESCRIPTION

Hereinafter, selected embodiments of the present disclosure will be described in detail with reference to the accompanying drawings. The embodiments to be described below are merely illustrative in nature and do not limit the scope of the present disclosure. Further, the configuration(s) and operation(s) described in each embodiment are not all essential in implementing the present disclosure. Note that like elements are referenced by like reference numerals and characters, and duplicate descriptions thereof will be omitted herein.

### Contents

1. Definition of terms
2. General descriptions of a laser apparatus

2.1 Configuration

2.2 Operation

3. Descriptions of solid-state light sources

3.1 A solid-state light source of a first embodiment

3.2 A solid-state light source of a second embodiment

3.3 A solid-state light source of a third embodiment

3.4 A solid-state light source of a fourth embodiment

3.5 A solid-state light source of a fifth embodiment

4. Laser light to be injected

4.1 A beam profile of laser light to be injected

4.2 A pulse width of laser light to be injected

4.3 Adjustment of a pulse width of laser light to be injected

### 1. DEFINITION OF TERMS

The terms used in the present disclosure are defined as follows.

In the present disclosure, the direction of travel of laser light is defined as a Z-direction. One direction perpendicular to the Z-direction is defined as an X-direction and a direction perpendicular to the X-direction and the Z-direction is defined as a Y-direction. While the direction of travel of laser light is the Z-direction, the X-direction and the Y-direction in the description may be changed depending on the direction of travel of laser light as described. For example, when the direction of travel of laser light (Z-direction) is changed in an X-Z plane, the X-direction after a change in the direction of travel is changed depending on the change in the direction of travel whereas the Y-direction is not changed. On the other hand, when the direction of travel of laser light (Z-direction) is changed in a Y-Z plane, the Y-direction after a change in the direction of travel is changed depending on the change in the direction of travel whereas the X-direction is not changed. For better understanding, an appropriate coordinate system will be illustrated for each of laser light entering an optical element located most upstream and laser light exiting from an optical element located most downstream among optical elements illustrated in each figure. An appropriate coordinate system will be illustrated for laser light incident on another optical element as necessary.

In the present disclosure, KBBF refers to a nonlinear optical crystal represented by a chemical formula of KBe₂BO₃F₂. LBO refers to a nonlinear optical crystal represented by a chemical formula of LiB₃O₅. BBO refers to a nonlinear optical crystal represented by a chemical formula of β-BaB₂O₄. CLBO refers to a nonlinear optical crystal represented by a chemical formula of CsLiB₆O₁₀. YAG refers to Y₃Al₅O₁₂ (Yttrium Aluminum Garnet). YAP refers to YAlO₃ (Yttrium Aluminum Perovskite). YLF refers to YLiF₄ (Yttrium Lithium Fluoride). A burst oscillation refers to outputting of pulsed laser light at a predetermined repetition frequency within a predetermined period of time. An optical path refers to a path for propagation of laser light. ω, ω₁, and ω₂ indicate angular frequencies of light and exhibit different values depending on a light source or the like.

### 2. GENERAL DESCRIPTIONS OF A LASER APPARATUS

2.1 Configuration

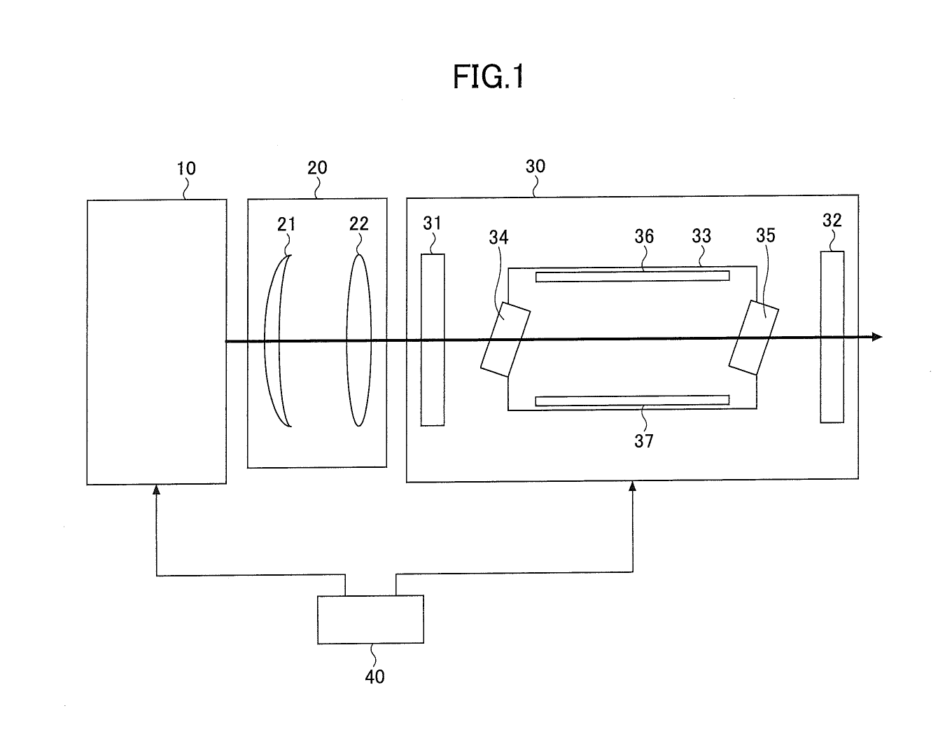

FIG. 1 illustrates an overview of a laser apparatus in the present disclosure. The laser apparatus may include a solid-state light source 10, an injection optical system 20, an amplifier 30, a controller 40, and the like. The solid-state light source 10 may emit laser light with a wavelength of about 193 nm or the like. The solid-state light source 10 may include an optical member such as a collimator lens that is not illustrated in the figure.

The injection optical system 20 may conduct shaping of a beam profile of laser light emitted from the solid-state light source 10. Hence, the injection optical system 20 may include a cylindrical lens pair for beam shaping that includes lenses 21 and 22.

The amplifier 30 may be an ArF excimer amplifier or the like. Specifically, a partial reflection mirror 31, an output coupler 32, and an excimer chamber 33 may be included, and the excimer chamber 33 may be installed between the partial refection mirror 31 and the output coupler 32. The excimer chamber 33 may be filled with gases of Ar, F₂, or the like, and may include an entrance window 34, an exit window 35, and electrodes 36 and 37 to cause discharging. The partial reflection mirror 31 and the output coupler 32 constitute a resonator.

The controller 40 may be synchronized in such a manner that a voltage is applied between the electrode 36 and the electrode 37 in the amplifier 30 when laser light emitted from the solid-state light source 10 is present in the space between the electrodes 36 and 37.

2.2 Operation

In the laser apparatus illustrated in FIG. 1, laser light may be emitted from the solid-state light source 10 and the emitted laser light may be shaped in the injection optical system 20 in such a manner that the beam profile of the laser light is a desired profile, and exit from the injection optical system 20. The laser light exiting from the injection optical system 20 may enter the interior of the excimer chamber 33 in the amplifier 30 via the partial reflection mirror 31 and the entrance window 34. In the excimer chamber 33, a voltage may be applied between the electrode 36 and the electrode 37 to cause discharging so that the laser light entering from the solid-state light source 10 may be amplified and exit via the exit window 35 and the output coupler 32.

### 3. DESCRIPTIONS OF SOLID-STATE LIGHT SOURCES

3.1 A Solid-State Light Source of a First Embodiment

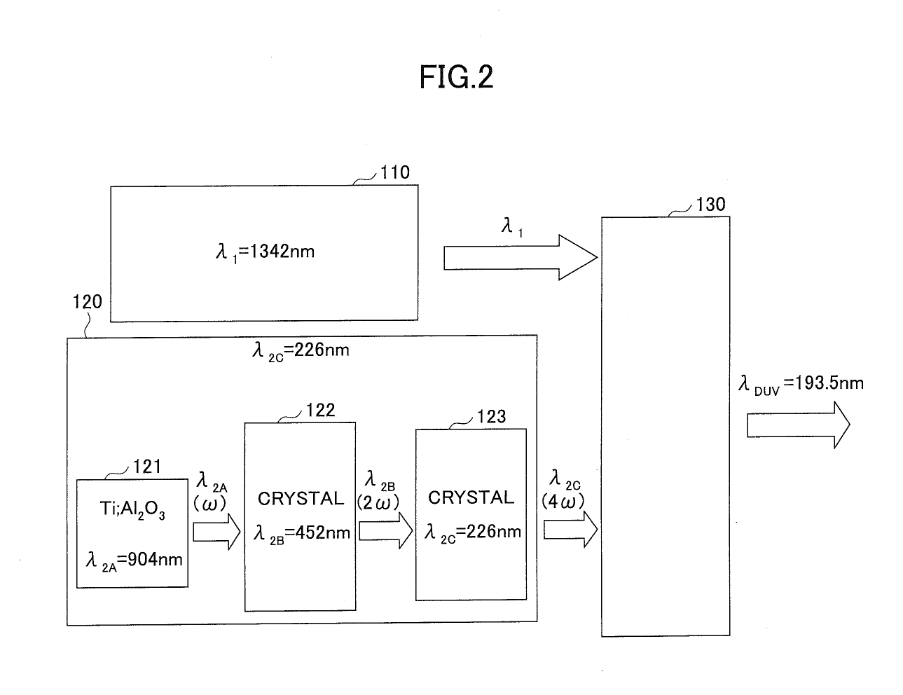

Next, a solid-state light source of a laser apparatus according to a first embodiment of the present disclosure will be described. The solid-state light source may be a master oscillator and correspond to the solid-state light source 10 illustrated in FIG. 1. The solid-state light source may include a first laser light source unit 110, a second laser light source unit 120, a VUV wavelength conversion element 130, and the like, as illustrated in FIG. 2.

The first laser light source unit 110 may be an Nd:YVO₄ laser device and emit light with a wavelength of 1342 nm (λ₁). The first laser light source unit 110 may be such that a power of 2 W or greater can be obtained in an operation at 6 kHz.

The second laser light source unit 120 may include a titanium-sapphire laser (Ti:Al₂O₃ laser) device 121, a first wavelength conversion element 122, and a second wavelength conversion element 123. The titanium-sapphire laser device 121 may emit light with a wavelength of 904 nm (λ_{2A}). Herein, a wavelength corresponding to an angular frequency ω will be described as the wavelength λ_{2A}. The titanium-sapphire laser device 121 is provided with a wide gain bandwidth and can oscillate at a wavelength of 650 nm to 1100 nm, and hence, may also readily be able to oscillate at a wavelength of 904 nm (λ_{2A}). The titanium-sapphire laser device 121 may be such that it is expected that a power of 10 W or greater can be obtained in an operation at 6 kHz.

The first wave conversion element 122 may be a crystal for conducting wavelength conversion of incident light with a wavelength of 904 nm (λ_{2A}) to emit light with a wavelength of 452 nm (λ_{2B}) and specifically, may be a Second Harmonic Generation (SHG) element. The first wavelength conversion element 122 may be made of any of LBO, BBO, CLBO, and KBBF, or the like.

The second wave conversion element 123 may be a crystal for conducting wavelength conversion of incident light with a wavelength of 452 nm (λ_{2B}) to emit light with a wavelength of 226 nm (λ_{2C}) and specifically, may be an SHG element. The second wavelength conversion element 123 may be made of BBO, KBBF, or the like. Thus, the first wave conversion element 122 and the second wave conversion element 123 may covert laser light with an angular frequency ω and a wavelength of 904 nm (λ_{2A}) emitted from the titanium-sapphire laser device 121 so as to emit laser light with an angular frequency 4ω and a wavelength of 226 nm (λ_{2C}). The wavelength of 226 nm (λ_{2C}) is one-fourth of the wavelength of 904 nm (λ_{2A})

The VUV wavelength conversion element 130 may be such that laser light with a wavelength of 1342 nm (λ₁) and laser light with a wavelength of 226 nm (λ_{2C}) are incident thereon to emit laser light with a wavelength of 193.5 nm (λ_{VUV}) that corresponds to a sum-frequency of the wavelengths λ₁ and λ_{2C}. That is, the VUV wavelength conversion element 130 may emit light with a wavelength of 193.5 nm (λ_{VUV}) based on incident laser light with a wavelength of 1342 nm (λ₁) from the first laser light source unit 110 and laser light with a wavelength of 226 nm (λ_{2C}) from the second laser light source unit 120. The VUV wavelength conversion element 130 may be made of CLBO, BBO, or the like.

In the laser apparatus, the titanium-sapphire laser device 121 (Ti:Al₂O₃ laser device 121) with a higher power and a higher coherence may be used in the second laser light source unit 120. Thereby, the power and coherence of laser light with a wavelength of 193.5 nm emitted from the VUV wavelength conversion element 130 may be able to be increased and laser light with a wavelength of 193.5 nm may be able to be generated efficiently.

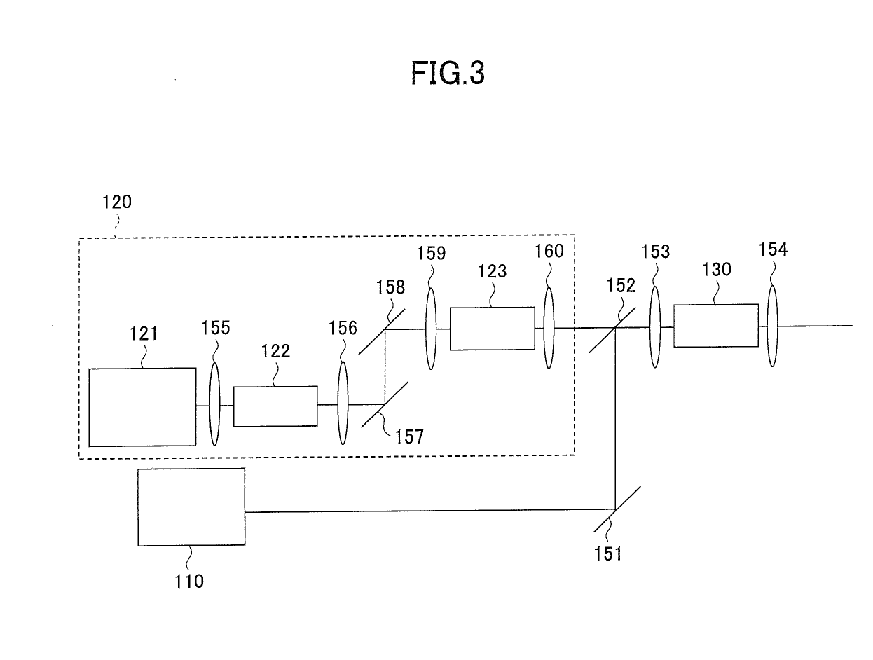

Next, one example of optical members in the solid-state light source of the first embodiment will be described in more detail with reference to FIG. 3.

The solid-state light source may include the first laser light source unit 110, the second laser light source unit 120, the VUV wavelength conversion element 130, a high-reflectance mirror 151, a dichroic mirror 152, a condenser lens 153, a collimator lens 154, and the like. The second laser light source unit 120 may include the titanium-sapphire laser device 121, condenser lenses 155 and 159, the first wavelength conversion element 122, collimator lenses 156 and 160, high-reflectance mirrors 157 and 158, and the second wavelength conversion element 123. The dichroic mirror 152 may reflect light with a wavelength λ₁ and transmit light with a wavelength λ_{2C}.

Laser light with a wavelength λ₁ emitted from the first laser light source unit 110 may be reflected from the high-reflectance mirror 151 and the dichroic mirror 152, and then, be incident on the VUV wavelength conversion element 130 via the condenser lens 153.

Laser light with an angular frequency ω and a wavelength λ_{2A} emitted from the titanium-sapphire laser device 121 may be incident on the first wavelength conversion element 122 via the condenser lens 155 and subjected to wavelength conversion in the first wavelength conversion element 122 so as to emit laser light with an angular frequency 2ω and a wavelength λ_{2B}. The laser light with a wavelength λ_{2B} emitted from the first conversion element 122 may pass through the collimator lens 156, then be reflected from the high-reflectance mirrors 157 and 158, and subsequently, be incident on the second wavelength conversion element 123 via the condenser lens 159. The laser light with an angular frequency 2ω and a wavelength λ_{2B} incident on the second wavelength conversion element 123 may be subjected to wavelength conversion in the second wavelength conversion element 123 so as to emit laser light with an angular frequency 4ω and a wavelength λ_{2C}. The laser light with a wavelength λ_{2B} emitted from the second wavelength conversion element 123 may transmit through the dichroic mirror 152 via the collimator lens 160, and then, be incident on the VUV wavelength conversion element 130 via the condenser lens 153. The laser light with a wavelength λ₁ and the laser light with a wavelength λ_{2C} may be incident on the VUV wavelength conversion element 130 to emit light with a wavelength corresponding to a sum frequency of the wavelength λ₁ and the wavelength λ_{2C}. The light with a wavelength corresponding to a sum frequency of the wavelength λ₁ and the wavelength λ_{2C} emitted from the VUV wavelength conversion element 130 may pass through and exit from the collimator lens 154 as laser light from the solid-state light source.

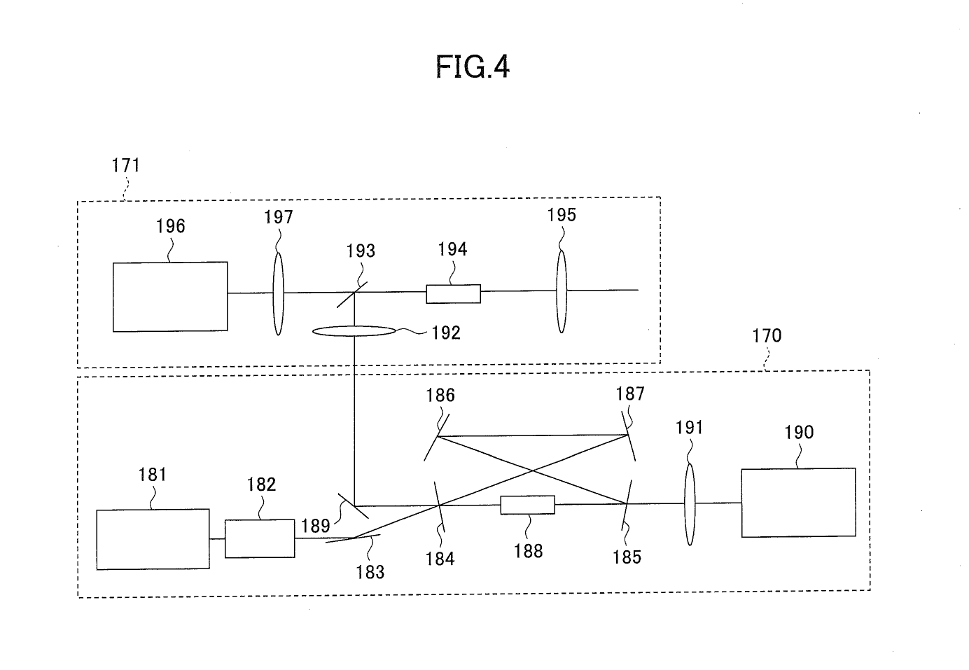

Next, one example of the titanium-sapphire laser device 121 will be described in more detail with reference to FIG. 4. The titanium-sapphire laser device 121 illustrated in FIG. 4 may include an oscillator 170 and an amplifier 171. The oscillator 170 may include a laser light source 181, an isolator 182, high-reflectance mirrors 183, 186, 187, and 189, an output coupler 184, a dichroic mirror 185, a Ti:Al₂O₃ crystal 188, an Nd:YAG laser device 190, and a condenser lens 191. The amplifier 171 may include a condenser lens 192, a dichroic mirror 193, a Ti:Al₂O₃ crystal 194, a collimator lens 195, an Nd:YAG laser device 196, and a condenser lens 197. The dischroic mirrors 185 and 193 may reflect light with a wavelength of 904 nm and transmit light with a wavelength of 532 nm. The output coupler 184 may reflect a portion of incident light and transmit the rest thereof. The Nd:YAG laser devices 190 and 196 may emit light with a wavelength of 532 nm as second harmonic waves. The laser light source 181 may be a semiconductor laser device such as a Distributed Feed-Back Laser Diode (DFB-LD) that emits light with a wavelength of 904 nm.

Laser light with a wavelength of 904 nm emitted from the laser light source 181 may enter a titanium-sapphire ring-type amplifier from the output coupler 184 via the isolator 182 and the high-reflectance mirror 183. The laser light with a wavelength of 904 nm entering from the output coupler 184 may be reflected from the high-reflectance mirrors 187 and 186, the dichroic mirror 185, and the output coupler 184. The Ti:Al₂O₃ crystal 188 may be provided on an optical path on which light reflected from the dichroic mirror 185 passes, so that the laser light may passes through the Ti:Al₂O₃ crystal 188.

On the other hand, light with a wavelength of 532 nm as second harmonic waves may be emitted from the Nd:YAG laser device 190 and incident on the Ti:Al₂O₃ crystal 188 via the condenser lens 191 and the dichroic mirror 185. Thereby, the light with a wavelength of 904 nm may be amplified in the Ti:Al₂O₃ crystal 188 and the amplified laser light with a wavelength of 904 nm may exit from the output coupler 184. The light with a wavelength of 904 nm exiting from the output coupler 184 may be reflected from the high-reflectance mirror 189 to enter the amplifier 171.

The laser light with a wavelength of 904 nm entering the amplifier 171 may pass through the condenser lens 192 and then be reflected from the dichroic mirror 193 to be incident on the Ti:Al₂O₃ crystal 194. In the amplifier 171, light with a wavelength of 532 nm, as second harmonic waves, may also be emitted from the Nd:YAG laser device 196, pass through the condenser lens 197, then transmit through the dichroic mirror 193, and be incident on the Ti:Al₂O₃ crystal 194. Thereby, the laser light with a wavelength of 904 nm may be amplified in the Ti:Al₂O₃ crystal 194 and pass through and exit from the collimator lens 195.

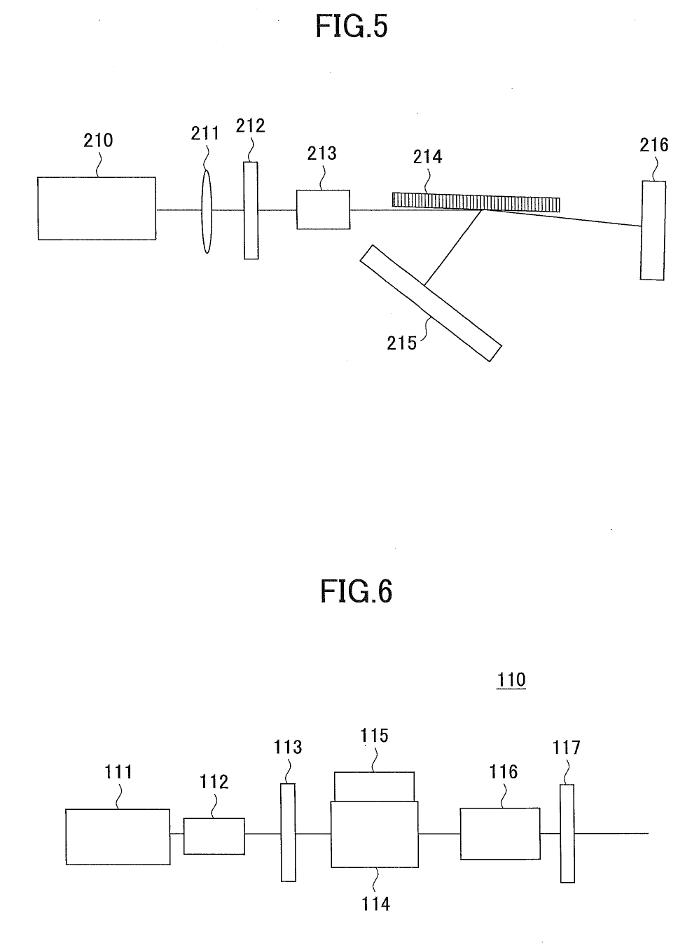

Next, another example of an oscillator in the titanium-sapphire laser device 121 will be described with reference to FIG. 5. An oscillator illustrated in FIG. 5 is a narrow bandwidth titanium-sapphire laser device and can be used instead of the oscillator 170 in FIG. 4. The oscillator in FIG. 5 may include an Nd:YAG laser device 210, a condenser lens 211, a dichroic mirror 212, a Ti:Al₂O₃ crystal 213, a grating 214, a high-reflectance mirror 215, and an output coupler 216. The dichroic mirror 212 may reflect light with a wavelength of 904 nm and transmit light with a wavelength of 532 nm. The Nd:YAG laser device 210 may emit light with a wavelength of 532 nm as second harmonic waves.

In the oscillator illustrated in FIG. 5, light with a wavelength of 532 nm emitted from the Nd:YAG laser device 210 may pass through the condenser lens 211, and then transmit through the dichroic mirror 212, and be incident on the Ti:Al₂O₃ crystal 213. Laser light with a central wavelength of 904 nm emitted from the Ti:Al₂O₃ crystal 213 may be incident on the grating 214 to be spectrally dispersed with respect to wavelengths, and the laser light reflected from the high-reflectance mirror 215 may be incident on the grating 214 again. Thereby, the spectral bandwidth of laser light may be able to be narrowed. Thus, light with a bandwidth narrowed by the grating 214 may be incident on the output coupler 216, and then, exit from the output coupler 216.

Next, the first laser light source unit 110 will be described with reference to FIG. 6. The laser light source unit 110 may include a laser light source 111, an isolator 112, a partial reflection mirror 113, an Nd:YVO₄ crystal 114, a laser light source for excitation 115, a Q-switch 116, and an output coupler 117. The laser light source 111 may be a semiconductor laser device, such as a DFB-LD, to emit light with a wavelength of 1342 nm. The partial reflection mirror 113 may be, for example, a mirror with a reflectance of about 90% and a transmittance of about 10%. The Q-switch 116 may be an Acousto-Optic Modulator (AOM). The output coupler 117 may be provided with, for example, a reflectance of about 50%.

Light with a wavelength of 1342 nm emitted from the laser light source 111 may pass through the isolator 112 and the partial reflection mirror 113 and be incident on the Nd:YVO₄ crystal 114. While the Nd:YVO₄ crystal 114 may be excited by the laser light source for excitation 115, light with a wavelength of 1342 nm emitted from the laser light source 111 may be incident thereon to emit light with a wavelength of 1342 nm. The light with a wavelength of 1342 nm emitted from the Nd:YVO₄ crystal 114 may pass through and exit from the Q-switch 116 and the output coupler 117 and the exiting laser light may be laser light emitted from the first laser light source 110.

3.2 A Solid-State Light Source of a Second Embodiment

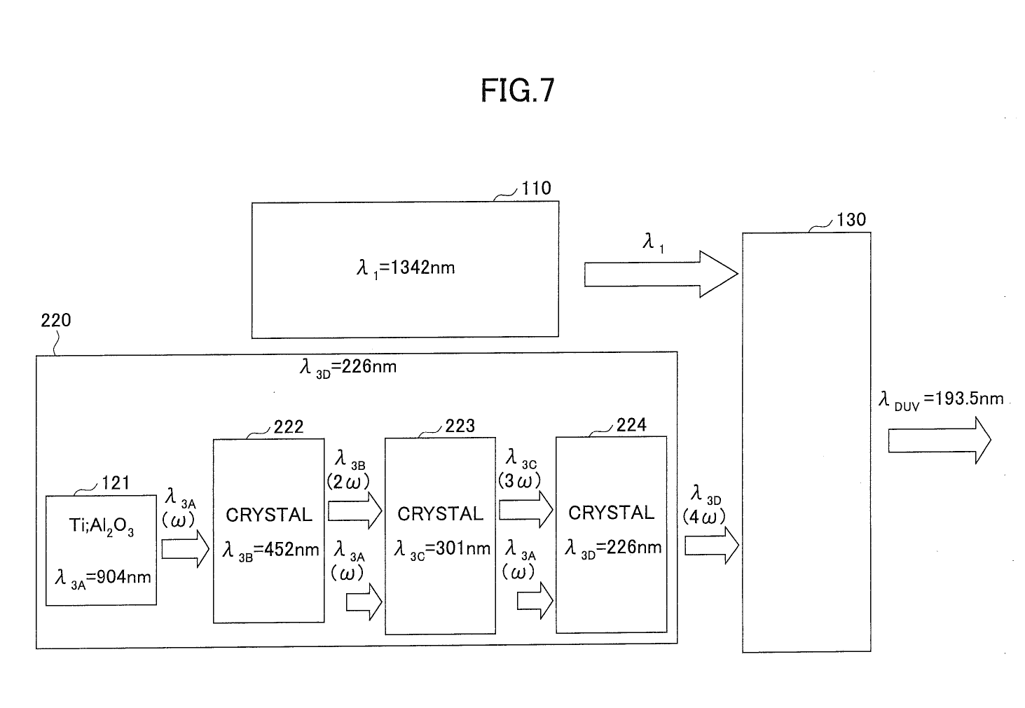

Next, a solid-state light source of a laser apparatus according to a second embodiment of the present disclosure will be described. The solid-state light source may be a master oscillator and correspond to the solid-state light source 10 illustrated in FIG. 1. As illustrated in FIG. 7, the solid-state light source may include a first laser light source unit 110, a second laser light source unit 220, a VUV wavelength conversion element 130, and the like.

The first laser light source unit 110 may be an Nd:YVO₄ laser device and emit light with a wavelength of 1342 nm (λ₁).

The second laser light source unit 220 may include a titanium-sapphire laser device 121, a first wavelength conversion element 222, a second wavelength conversion element 223, and a third wavelength conversion element 224. The titanium-sapphire laser device 121 may emit light with a wavelength of 904 nm (λ_{3A}). Herein, the wavelength λ_{3A} will be described as a wavelength corresponding to an angular frequency ω. The titanium-sapphire laser device 121 has a wider gain bandwidth and can oscillate at a wavelength of 650 nm to 1100 nm, and hence, may readily be able to oscillate even at a wavelength of 904 nm (λ_{3A}).

The first wavelength conversion element 222 may be a crystal for converting the wavelength of a portion of incident light with a wavelength of 904 nm (λ_{3A}) so as to emit light with a wavelength of 452 nm (λ_{3B}), and specifically, an SHG element. Herein, light with a wavelength of 904 nm (λ_{3A}) that is not subjected to wavelength conversion may also be emitted. The first wavelength conversion element 122 may be made of any of LBO, BBO, CLBO, and KBBF, or the like.

The second wavelength conversion element 223 may be a crystal provided in such a manner that light with a wavelength of 904 nm (λ_{3A}) and light with a wavelength of 452 nm (λ_{3B}) are incident thereon to emit light with a wavelength of 301 nm (λ_{3C}) corresponding to a sum frequency of 904 nm (λ_{3A}) and 452 nm (λ_{3B}). Herein, light with a wavelength of 904 nm (λ_{3A}) that is not subjected to wavelength conversion may also be emitted. The second wavelength conversion element 223 may be made of any of LBO, BBO, CLBO, and KBBF, or the like.

The third wavelength conversion element 224 may be a crystal provided in such a manner that light with a wavelength of 904 nm (λ_{3A}) and light with a wavelength of 301 nm (λ_{3D}) are incident thereon to emit light with a wavelength of 226 nm (λ_{3D}) corresponding to a sum frequency of 904 nm (λ_{3A}) and 301 nm (λ_{3C}). The third wavelength conversion element 224 may be made of any of BBO, CLBO, and KBBF, or the like. Hence, laser light with an angular frequency ω and a wavelength of 904 nm (λ_{3A}) may be converted by the first wavelength conversion element 222, the second wavelength conversion element 223, and the third wavelength conversion element 224 so as to emit laser light with an angular frequency 4ω and a wavelength of 226 nm (λ_{3D}). The wavelength of 226 nm (λ_{3D}) is a wavelength that is one-fourth of the wavelength of 904 nm (λ_{3A}).

The VUV wavelength conversion element 130 may be such that laser light with a wavelength of 1342 nm (λ₁) and laser light with a wavelength of 226 nm (λ_{3D}) are incident thereon to emit laser light with a wavelength of 193.5 nm (λ_{VUV}) corresponding to a sum frequency of the wavelength λ₁ and the wavelength λ_{3D}. That is, the VUV wavelength conversion element 130 may emit light with a wavelength of 193.5 nm (λ_{VUV}) based on laser light with a wavelength of 1342 nm (λ₁) from the first laser light source unit 110 and laser light with a wavelength of 226 nm (λ_{3D}) from the second laser light source unit 220. The VUV wavelength conversion element 130 may be made of CLBO, BBO, or the like.

The titanium-sapphire laser device 121 with a higher power and a higher coherence may be used in the second laser light source unit 220 of the laser apparatus. Thereby, the power and coherence of laser light with a wavelength of 193.5 nm emitted from the VUV wavelength conversion element 130 can be increased, and laser light with a wavelength of 193.5 nm may be able to be generated efficiently.

In the solid-state light source illustrated in FIG. 7, a nonlinear crystal is used for the second wavelength conversion element 223, so that CLBO, or the like, as nonlinear crystals, may be able to be used for the third wavelength conversion element 224. That is, CLBO has an absorption edge at a shorter wavelength as compared to BBO, and hence, elements constituting the crystal have higher binding energies to cause lesser degree of crystal degradation. A crystal with a larger size can readily be produced, and hence, the wavelength can be converted at a higher efficiency.

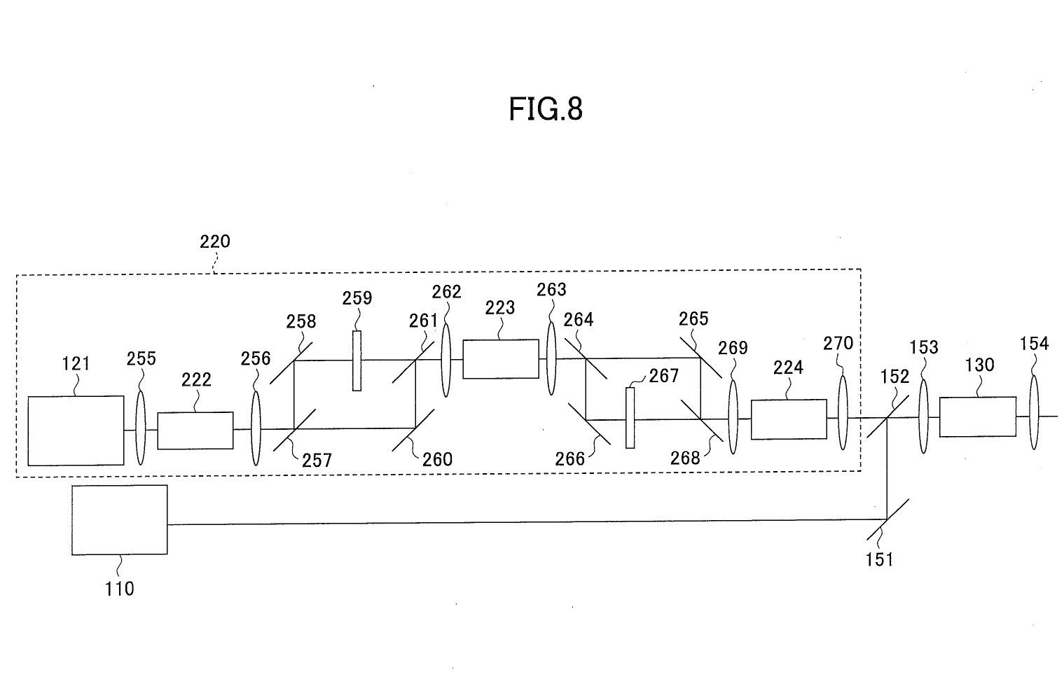

Next, one example of arrangement of optical members in the solid-state light source of the second embodiment will be described in more detail with reference to FIG. 8.

The solid-state light source may include the first laser light source unit 110, the second laser light source unit 220, the VUV wavelength conversion element 130, a high-reflectance mirror 151, a dichroic mirror 152, a condenser lens 153, and a collimator lens 154. The second laser light source unit 220 may include the titanium-sapphire laser device 121, the first wavelength conversion element 222, the second wavelength conversion element 223, the third wavelength conversion element 224, and condenser lenses 255, 262, and 269. Moreover, the second laser light source unit 220 may include collimator lenses 256, 263, and 270, dichroic mirrors 257, 261, 264, and 268, high-reflectance mirrors 258, 260, 265, and 266, and half-wave plates 259 and 267. The dichroic mirror 152 may reflect light with a wavelength λ₁ and transmit light with a wavelength λ_{3D}. The dichroic mirror 257 may reflect light with a wavelength λ_{3B} and transmit light with a wavelength λ_{3A}. The dichroic mirror 261 may reflect the light with a wavelength λ_{3A} and transmit light with a wavelength λ_{3B}. The dichroic mirror 264 may reflect light with a wavelength λ_{3C} and transmit the light with a wavelength λ_{3A}. The dichroic mirror 268 may reflect the light with a wavelength λ_{3A} and transmit light with a wavelength λ_{3C}.

Laser light with a wavelength λ₁ emitted from the first laser light source unit 110 may be reflected from the high-reflectance mirror 151 and the dichroic mirror 152 and then be incident on the VUV wavelength conversion element 130 via the condenser lens 153.

Laser light with a wavelength λ_{3A} emitted from the titanium-sapphire laser device 121 may be incident on the first wavelength conversion element 222 via the condenser lens 255, and a portion thereof may be subjected to wavelength conversion in the first wavelength conversion element 222 so as to emit laser light with a wavelength λ_{3B}. Herein, laser light that is not subjected to wavelength conversion in the first wavelength conversion element 222 may be emitted from the first wavelength conversion element 222 as laser light with a wavelength λ_{3A}.

Thus, the laser light with a wavelength λ_{3A} and laser light with a wavelength λ_{3B} emitted from the first wavelength conversion element 222 may pass through the collimator lens 256, and then, the laser light with a wavelength λ_{3A} and the laser light with a wavelength λ_{3B} may be separated from each other by the dichroic mirror 257. Specifically, the dichroic mirror 257 may transmit the laser light with a wavelength λ_{3A} and reflect the laser light with a wavelength λ_{3B} to be separated from each other. Then, the laser light with a wavelength λ_{3A} transmitting through the dichroic mirror 257 may be reflected from the high-reflectance mirror 260 and the dichroic mirror 261 and be incident on the second wavelength conversion element 223 via the condenser lens 262. The laser light with a wavelength λ_{3B} reflecting from the dichroic mirror 257 may be reflected from the high-reflectance mirror 258, pass through the half-wave plate 259, transmit through the dichroic mirror 261, pass through the condenser lens 262, and be incident on the second wavelength conversion element 223.

The laser light with a wavelength λ_{3A} and the laser light with a wavelength λ_{3B} may be incident on the second wavelength conversion element 223 so that sum-frequency wavelength conversion may be applied to a portion thereof in the second wavelength conversion element 223 so as to emit the laser light with a wavelength λ_{3C}. Herein, laser light that is not subjected to wavelength conversion in the second wavelength conversion element 223 may be emitted from the second wavelength conversion element 223 as laser light with a wavelength λ_{3A}.

Thus, the laser light with a wavelength λ_{3A} and laser light with a wavelength λ_{3C} that are emitted from the second wavelength conversion element 223 may pass through the collimator lens 263, and then, the laser light with a wavelength λ_{3A} and the laser light with a wavelength λ_{3C} may be separated from each other by the dichroic mirror 264. Specifically, the dichroic mirror 264 may transmit the laser light with a wavelength λ_{3A} and reflect the laser light with a wavelength λ_{3C} to be separated from each other. Then, the laser light with a wavelength λ_{3A} transmitting through the dichroic mirror 264 may be reflected from the high-reflectance mirror 265 and the dichroic mirror 268 and be incident on the third wavelength conversion element 224 via the condenser lens 269. The laser light with a wavelength λ_{3C} reflecting from the dichroic mirror 264 may be reflected from the high-reflectance mirror 266, pass through the half-wave plate 267, transmit through the dichroic mirror 268, pass through the condenser lens 269, and be incident on the third wavelength conversion element 224.

The laser light with a wavelength λ_{3A} and the laser light with a wavelength λ_{3C} may be incident on the third wavelength conversion element 224 so that sum-frequency wavelength conversion may be conducted in the third wavelength conversion element 224 so as to emit the laser light with a wavelength λ_{3D}. The laser light with a wavelength λ_{3D} emitted from the third wavelength conversion element 224 may transmit through the dichroic mirror 152 via the collimator lens 270, and then, be incident on the VUV wavelength conversion element 130 via the condenser lens 153. Light with a wavelength corresponding to a sum frequency of laser light with a wavelength λ₁ and laser light with a wavelength λ_{3D} incident on the VUV wavelength conversion element 130 may be emitted therefrom and pass through the collimator lens 154 so as to be emitted as laser light from the solid-state light source.

Table 1 illustrates combinations of the first laser light source unit 110 and the titanium-sapphire laser device 121 in the second laser light source unit 120 or 200 that can be adopted in the first and second embodiments including the cases described above. Specifically, the case where Nd:YAG, Nd:YAP, or ND:YLF is used for the first laser light source unit 110 is illustrated therein.

TABLE 1

| | |
|---|---|
| | Second laser light |
| First laser light | source unit |
| source unit | Ti:Al₂O₃ |

| Gain medium | Wavelength λ₁ | ω | 4ω |
|---|---|---|---|
| Nd:YAG | 1112 nm | 937 nm | 234 nm |
| | 1116 nm | 936 nm | 234 nm |
| | 1123 nm | 935 nm | 234 nm |
| | 1319 nm | 907 nm | 227 nm |
| | 1338 nm | 905 nm | 226 nm |
| Nd:YAP | 1318 nm | 907 nm | 227 nm |
| | 1342 nm | 904 nm | 226 nm |
| Nd:YLF | 1313 nm | 908 nm | 227 nm |
| | 1321 nm | 907 nm | 227 nm |

The combination may be such that an Nd:YAG laser device that emits light with a wavelength λ1 of 1112 nm is used for the first laser light source unit 110 and a titanium-sapphire laser device 121 that emits light with a wavelength of 937 nm is used for the second laser light source unit 120, so that an angular frequency 4ω and a wavelength of 234 nm are provided.

The combination may be such that an Nd:YAG laser device that emits light with a wavelength λ₁ of 1116 nm is used for the first laser light source unit 110 and a titanium-sapphire laser device 121 that emits light with an angular frequency ω and a wavelength of 936 nm is used for the second laser light source unit 120, so that an angular frequency 4ω and a wavelength of 234 nm are provided.

The combination may be such that an Nd:YAG laser device that emits light with a wavelength λ₁ of 1123 nm is used for the first laser light source unit 110 and a titanium-sapphire laser device 121 that emits light with an angular frequency ω and a wavelength of 935 nm is used for the second laser light source unit 120, so that an angular frequency 4ω and a wavelength of 234 nm are provided.

The combination may be such that an Nd:YAG laser device that emits light with a wavelength λ₁ of 1319 nm is used for the first laser light source unit 110 and a titanium-sapphire laser device 121 that emits light with an angular frequency ω and a wavelength of 907 nm is used for the second laser light source unit 120, so that an angular frequency 4ω and a wavelength of 227 nm are provided.

The combination may be such that an Nd:YAG laser device that emits light with a wavelength λ₁ of 1338 nm is used for the first laser light source unit 110 and a titanium-sapphire laser device 121 that emits light with an angular frequency ω and a wavelength of 905 nm is used for the second laser light source unit 120, so that an angular frequency 4ω and a wavelength of 226 nm are provided.

The combination may be such that an Nd:YAP laser device that emits light with a wavelength λ₁ of 1318 nm is used for the first laser light source unit 110 and a titanium-sapphire laser device 121 that emits light with an angular frequency ω and a wavelength of 907 nm is used for the second laser light source unit 120, so that an angular frequency 4ω and a wavelength of 227 nm are provided.

The combination may be such that an Nd:YAP laser device that emits light with a wavelength λ₁ of 1342 nm is used for the first laser light source unit 110 and a titanium-sapphire laser device 121 that emits light with an angular frequency ω and a wavelength of 904 nm is used for the second laser light source unit 120, so that an angular frequency 4ω and a wavelength of 226 nm are provided.

The combination may be such that an Nd:YLF laser device that emits light with a wavelength λ₁ of 1313 nm is used for the first laser light source unit 110 and a titanium-sapphire laser device 121 that emits light with an angular frequency ω and a wavelength of 908 nm is used for the second laser light source unit 120, so that an angular frequency 4ω and a wavelength of 227 nm are provided.

The combination may be such that an Nd:YLF laser device that emits light with a wavelength λ₁ of 1321 nm is used for the first laser light source unit 110 and a titanium-sapphire laser device 121 that emits light with an angular frequency ω and a wavelength of 907 nm is used for the second laser light source unit 120, so that an angular frequency 4ω and a wavelength of 227 nm are provided.

3.3 A Solid-State Light Source of a Third Embodiment

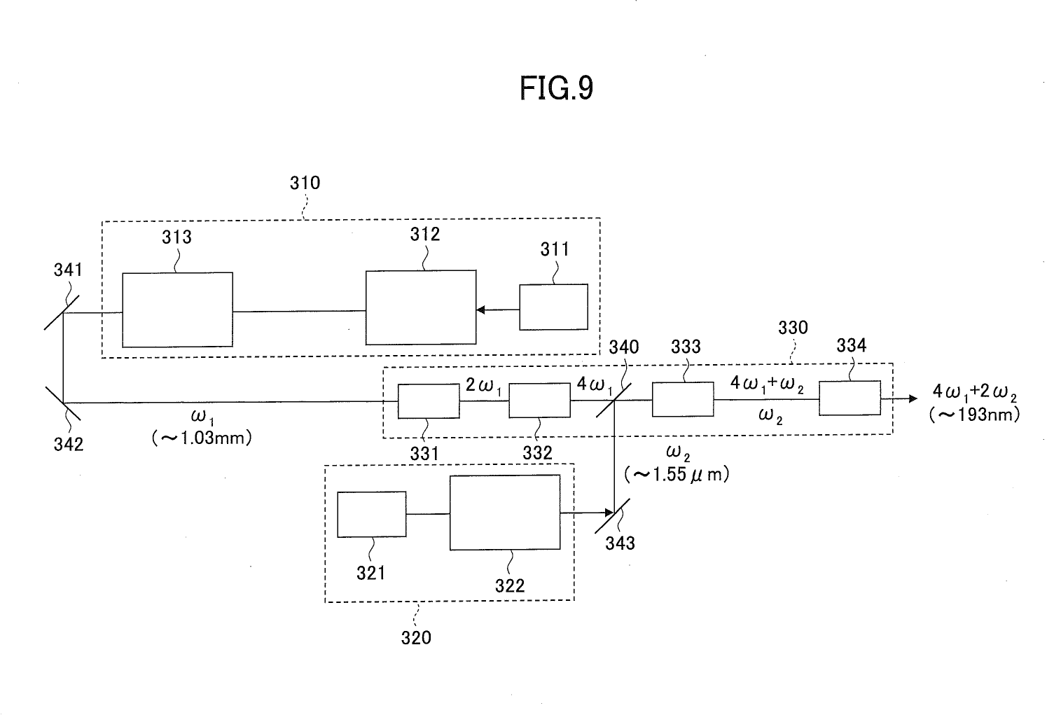

Next, a solid-state light source of a laser apparatus according to a third embodiment of the present disclosure will be described. The solid-state light source may be a master oscillator and correspond to the solid-state light source 10 illustrated in FIG. 1. The solid-state light source as illustrated in FIG. 9 may include a first laser light source unit 310, a second laser light source unit 320, a wavelength conversion unit 330, and the like. The first laser light source unit 310 may include a first semiconductor laser device 311, a photonic crystal amplifier 312, a Yb:YAG amplifier 313, and the like. The first laser light source unit 310 may emit laser light with a wavelength of about 1030 nm that corresponds to ω₁. The second laser light source unit 320 may include a second semiconductor laser device 321, a fiber laser amplifier 322, and the like, and emit laser light with a wavelength of about 1550 nm that corresponds to ω₂.

The first semiconductor laser device 311 may be a single-longitudinal-mode semiconductor laser device and the photonic crystal amplifier 312 may be a Yb-doped photonic crystal fiber laser amplifier. The second semiconductor laser device 321 may be a single-longitudinal-mode semiconductor laser device and the fiber laser amplifier 322 may be an Er-doped fiber laser amplifier.

The wavelength conversion unit 330 may include a first wavelength conversion element 331, a second wavelength conversion element 332, a third wavelength conversion element 333, a VUV wavelength conversion element 334, a dichroic mirror 340, and the like. The first wavelength conversion element 331 may be an SHG element configured in such a manner that light with ω₁ is incident thereon to emit laser light with 2ω₁ that corresponds to light with a wavelength that is a half of the wavelength of light with ω₁, or the like. The second wavelength conversion element 332 may be an SHG element configured in such a manner that light with 2ω₁ is incident thereon to emit light with 4ω₁ that corresponds to light with a wavelength that is a half of the wavelength of light with 2ω₁, or the like. The third wavelength conversion element 333 may be such that light with 4ω₁ and light with ω₂ are incident thereon to emit light with 4ω₁+ω₂ that is a sum frequency of 4ω₁ and ω₂. Herein, light with ω₂ may also be emitted in combination. The VUV wavelength conversion element 334 may be such that light with 4ω₁+ω₂ and light with ω₂ are incident thereon to emit light with 4ω₁+2ω₂ that is a sum frequency of 4ω₁+ω₂ and ω₂. The VUV wavelength conversion element 334 may be made of CLBO and light with 4ω₁+2ω₂ emitted from the VUV wavelength conversion element 334 may be light with a wavelength of about 193 nm. The dichroic mirror 340 may be provided between the second wavelength conversion element 332 and the third wavelength conversion element 333 and may transmit light with 4ω₁ and reflect light with ω₂.

In the first laser light source unit 310, laser light emitted from the first semiconductor laser device 311 may be incident on the photonic crystal amplifier 312 and amplified in the photonic crystal amplifier 312, and then, emitted from the photonic crystal amplifier 312. The laser light emitted from the photonic crystal amplifier 312 may be incident on the Yb:YAG amplifier 313 and amplified in the Yb:YAG amplifier 313, and then, laser light with a wavelength of about 1030 nm that corresponds to ω₁ may be emitted from the Yb:YAG amplifier 313. Then, the laser light with a wavelength of about 1030 nm that corresponds to ω₁ emitted from the Yb:YAG amplifier 313 may be reflected from the mirrors 341 and 342 and be incident on the wavelength conversion unit 330.

In the second laser light source unit 320, laser light emitted from the second semiconductor laser device 321 may be incident on the fiber laser amplifier 322 and amplified in the fiber laser amplifier 322, and then, laser light with a wavelength of about 1550 nm that corresponds to ω₂ may be emitted therefrom. Then, the laser light with a wavelength of about 1550 nm that corresponds to ω₂ emitted from the fiber laser amplifier 322 may be reflected from the mirror 343 and be incident on the dichroic mirror 340 in the wavelength conversion unit 330.

Light with ω₁ incident on the wavelength conversion unit 330 may be incident on the first wavelength conversion element 331 and subjected to wavelength conversion in the first wavelength conversion element 331 so as to emit light with 2ω₁ that corresponds to a wavelength that is a half of the wavelength of light with ω₁. The light with 2ω₁ emitted from the first wavelength conversion element 331 may be incident on the second wavelength conversion element 332 and subjected to wavelength conversion in the second wavelength conversion element 332 so as to emit light with 4ω₁ that is a wavelength that is a half of the wavelength of the light with 2ω₁. Then, the light with 4ω₁ emitted from the second wavelength conversion element 332 may transmit through the dichroic mirror 340 and be incident on the third wavelength conversion element 333. The light with ω₂ entering the dichroic mirror 340 in the wavelength conversion unit 330 from the second laser light source unit 320 may be reflected from the dichroic mirror 340 and be incident on the third wavelength conversion element 333. The light with 4ω₁ and the light with ω₂ may be incident on the third wavelength conversion element 333 to emit light with 4ω₁+ω₂ that is a sum frequency of the light with 4ω₁ and the light with ω₂. Herein, light with ω₂ that is not subjected to wavelength conversion may also be emitted from the third wavelength conversion element 333. Thus, the light with 4ω₁+ω₂ and the light with ω₂ emitted from the third wavelength conversion element 333 may be incident on the VUV wavelength conversion element 334. The light with 4ω₁+ω₂ and the light with ω₂ may be incident on the VUV wavelength conversion element 334 to emit the light with 4ω₁+2ω₂ that is a sum frequency of the light with 4ω₁+ω₂ and the light with ω₂. Thus, the light with 4ω₁+2ω₂, that is, light with a wavelength of about 193 nm, may be emitted from the VUV wavelength conversion element 334 as light emitted from the wavelength conversion unit 330. A wavelength corresponding to 4ω₁+2ω₂ is a wavelength corresponding to a sum frequency of a wavelength that is one-fourth of a wavelength corresponding to ω₁ and a wavelength that is one-half of a wavelength corresponding to ω₂.

If amplification is conducted by only the Yb-doped photonic crystal fiber laser amplifier, a spectral line may be broadened due to the nonlinearity of a fiber (Kerr-effect). On the other hand, when an output at about 1030 nm is obtained by the Yb:YAG amplifier 313, an injection-locked Yb:YAG resonator may have to be assembled and hence, a structure susceptible to vibration, or the like, may be provided. However, the solid-state light source illustrated in FIG. 9 may not readily be influenced with vibration, or the like, and may be able to obtain needed energy at even a narrower bandwidth, because final stage amplification is conducted in the Yb:YAG amplifier 313 that includes no resonator structure.

3.4 A Solid-State Light Source of a Fourth Embodiment

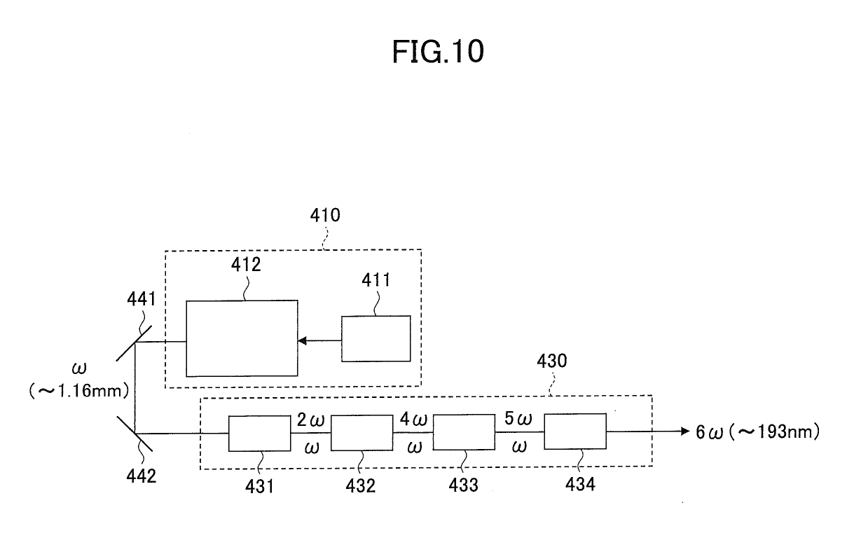

Next, a solid-state light source of a laser apparatus according to a fourth embodiment of the present disclosure will be described. The solid-state light source may be a master oscillator and correspond to the solid-state light source 10 illustrated in FIG. 1. The solid-state light source as illustrated in FIG. 10 may include a laser light source unit 410, a wave conversion unit 430, and the like. The laser light source unit 410 may include a semiconductor laser device 411, a fiber laser amplifier 412, and the like, and emit laser light with a wavelength of about 1160 nm corresponding to ω.

The semiconductor laser device 411 may be a single-longitudinal-mode semiconductor laser device and the fiber laser amplifier 412 may be an Yb-doped photonic band gap fiber laser amplifier that is a kind of photonic crystal fiber.

The wavelength conversion unit 430 may include a first wavelength conversion element 431, a second wavelength conversion element 432, a third wavelength conversion element 433, a VUV wavelength conversion element 434, and the like. The first wavelength conversion element 431 may be an SHG element configured in such a manner that light with an angular frequency ω is incident thereon to emit laser light with an angular frequency 2ω that is light with a wavelength that is a half of the wavelength of the light with an angular frequency ω, or the like. The second wavelength conversion element 432 may be an SHG element configured in such a manner that light with an angular frequency 2ω is incident thereon to emit laser light with an angular frequency 4ω that is light with a wavelength that is a half of the wavelength of the light with an angular frequency 2ω, or the like. The third wavelength conversion element 433 may be such that the light with an angular frequency 4ω and the light with an angular frequency ω are incident thereon to emit light with an angular frequency 5ω that is a sum frequency of 4ω and ω. The VUV wavelength conversion element 434 may be such that the light with an angular frequency 5ω and the light with an angular frequency ω are incident thereon to emit light with an angular frequency that is a sum frequency of 5ω and ω. The VUV wavelength conversion element 434 may be made of CLBO. Light with 6ω emitted from the VUV wavelength conversion element 434 may be provided with a wavelength of about 193 nm.

In the laser light source unit 410, laser light emitted from the semiconductor laser device 411 may be incident on the fiber laser amplifier 412 and amplified in the fiber laser amplifier 412, and then, laser light with an angular frequency ω and a wavelength of about 1160 nm may be emitted therefrom. Then, reflection from the mirrors 441 and 442 and incidence on the wavelength conversion unit 430 may be conducted.

The light with an angular frequency ω incident on the wavelength conversion unit 430 may be incident on the first wavelength conversion element 431 and subjected to wavelength conversion in the first wavelength conversion element 431 so as to emit light with an angular frequency 2ω corresponding to a wavelength that is a half of the wavelength of the incident light with an angular frequency ω. The light with an angular frequency 2ω emitted from the first wavelength conversion element 431 may be incident on the second wavelength conversion element 432 and subjected to wavelength conversion in the second wavelength conversion element 432 so as to emit light with an angular frequency 4ω corresponding to a wavelength that is a half of the wavelength of the incident light with an angular frequency 2ω. In the first wavelength conversion element 431, light with an angular frequency ω that is not subjected to wavelength conversion may also be incident on the second wavelength conversion element 432 and emitted from the second wavelength conversion element 432. Then, the light with an angular frequency 4ω and light with an angular frequency ω emitted from the second wavelength conversion element 432 may be incident on the third wavelength conversion element 433. In the third wavelength conversion element 433, the light with an angular frequency 4ω and light with an angular frequency ω may be incident thereon to emit light with an angular frequency 5ω that is a sum frequency of the light with an angular frequency 4ω and light with an angular frequency ω. Herein, light with an angular frequency ω that is not subjected to wavelength conversion may also be emitted from the third wavelength conversion element 433. Then, the light with an angular frequency 5ω and light with an angular frequency ω emitted from the third wavelength conversion element 433 may be incident on the VUV wavelength conversion element 434. The light with an angular frequency 5ω and the light with an angular frequency ω may be incident on the VUV wavelength conversion element 434 to emit light with an angular frequency 6ω that is a sum frequency of the light with an angular frequency 5ω and the light with an angular frequency ω. Thus, the light with an angular frequency 6ω and a wavelength of about 193 nm may be emitted from the VUV wavelength conversion element 434 as light emitted from the wavelength conversion unit 430.

The solid-state light source illustrated in FIG. 10 may be advantageous for miniaturization of an apparatus and cost reduction, because a laser unit for generating fundamental harmonic laser light can be composed of a semiconductor laser device and a fiber. The number of nonlinear crystals for forming a wavelength conversion element is four that is small, and hence, a higher total conversion efficiency and a higher output can be obtained which may be advantageous from the viewpoints of cost reduction, miniaturization, maintenance, or the like. The fiber laser amplifier 412 can be composed of a photonic crystal fiber laser amplifier so that an effective core diameter is 50 μm or greater, and a self phase modulation effect caused by Kerr effect in a fiber can be suppressed so that a spectral line with a narrow width may be able to be obtained. A higher power can be obtained from an Yb-doped fiber laser amplifier than an Er-doped fiber laser amplifier, and hence, a higher power of laser light with a wavelength of about 193 nm may be obtained.

3.5 A Solid-State Light Source of a Fifth Embodiment

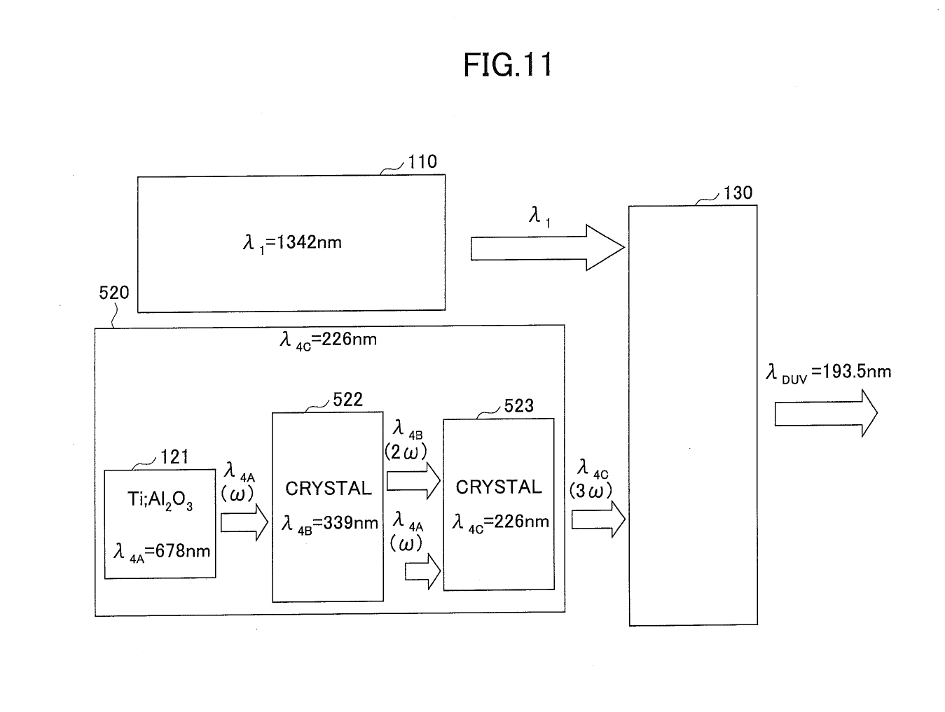

Next, a solid-state light source of a laser apparatus according to a fifth embodiment of the present disclosure will be described. The solid-state light source may be a master oscillator and correspond to the solid-state light source 10 illustrated in FIG. 1. The solid-state light source as illustrated in FIG. 11 may include a first laser light source unit 110, a second laser light source unit 520, a VUV wavelength conversion element 130, and the like.

The first laser light source unit 110 may be an Nd:YVO₄ laser device and may emit light with a wavelength of 1342 nm (λ₁).

The second laser light source unit 520 may include a titanium-sapphire laser device 121, a first wavelength conversion element 522, and a second wavelength conversion element 523. The titanium-sapphire laser device 121 may emit light with a wavelength of 678 nm (λ_{4A}). Herein, the wavelength λ_{4A} will be described as a wavelength corresponding to ω. The titanium-sapphire laser device 121 is provided with a wide gain bandwidth and can oscillate at a wavelength of 650 nm to 1100 nm, and hence, may also readily be able to oscillate at a wavelength of 678 nm (λ_{4A}).

The first wave conversion element 522 may be a crystal for conducting wavelength conversion of incident light with a wavelength of 678 nm (λ_{4A}) to emit light with a wavelength of 339 nm (λ_{4B}), and specifically, may be an SHG element. The first wavelength conversion element 522 may be made of any of LBO, BBO, CLBO, and KBBF, or the like.

The second wave conversion element 523 may be a crystal configured in such a manner that light with a wavelength of 678 nm (λ_{4A}) and light with a wavelength of 339 nm (λ_{4B}) are incident thereon to emit light with a wavelength of 226 nm (λ_{4C}) that corresponds to a sum frequency of 678 nm (λ_{4A}) and 339 nm (λ_{4B}). The second wavelength conversion element 523 may be made of any of BBO, CLBO, and KBBF, or the like.

Hence, the laser light with a wavelength of 678 nm (λ_{4A}) emitted from the titanium-sapphire laser device 121 may be converted by the first wave conversion element 522 and the second wave conversion element 523 so as to emit laser light with an angular frequency 3ω and a wavelength of 226 nm (λ_{4C}). The angular frequency 3ω or a wavelength of 226 nm (λ_{4C}) corresponds to one-third of a wavelength corresponding to the angular frequency ω or a wavelength of 678 nm (λ_{4A}).

The VUV wavelength conversion element 130 may be such that the laser light with a wavelength of 1342 nm (λ₁) and the laser light with a wavelength of 226 nm (λ_{4C}) are incident thereon to emit laser light with a wavelength of 193.5 nm (λ_{VUV}) that corresponds to a sum frequency of the wavelength λ₁ and the wavelength λ_{4C}. That is, the VUV wavelength conversion element 130 may be such that the laser light with a wavelength of 1342 nm (λ₁) from the first laser light source unit 110 and the laser light with a wavelength of 226 nm (λ_{4C}) from the second laser light source unit 520 are incident thereon to emit the light with a wavelength of 193.5 nm (λ_{VUV}). The VUV wavelength conversion element 130 may be made of CLBO, BBO, or the like.

The solid-state light source illustrated in FIG. 11 twice applies wavelength conversion to light emitted from the titanium-sapphire laser device 121 so that light with a wavelength of 226 nm can be generated, and may be advantageous for cost reduction and miniaturization. CLBO can be used for the second wavelength conversion element 523 for generating light with a wavelength of 226 nm, and hence, light with a wavelength of 226 nm may be able to be generated more efficiently.

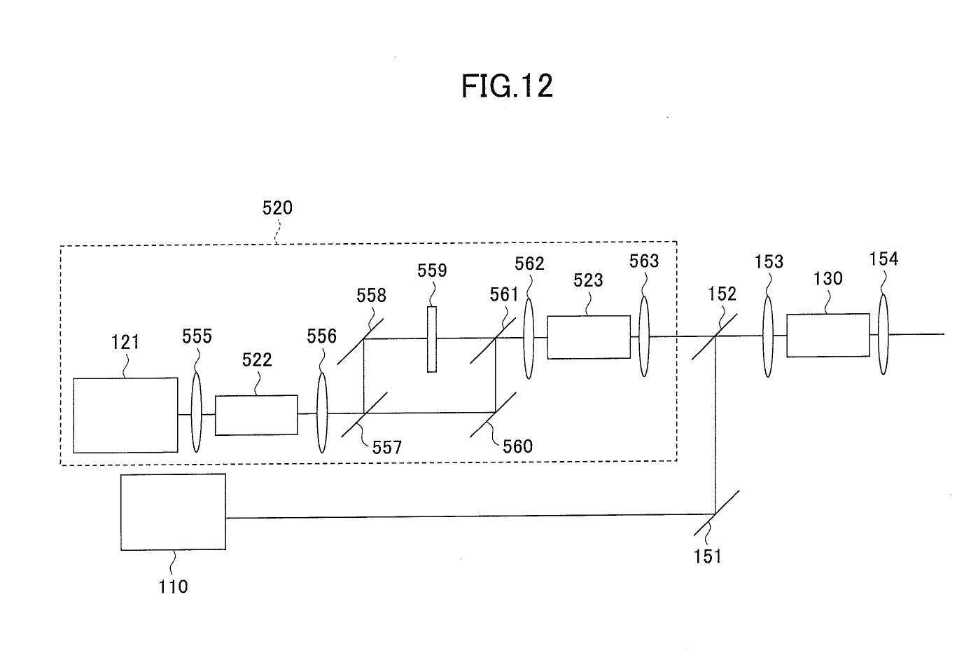

Next, one example of arrangement of optical members in the solid-state light source of the fifth embodiment will be described in more detail with reference to FIG. 12.

The solid-state light source may include a first laser light source unit 110, a second laser light source unit 520, a VUV wavelength conversion element 130, a high-reflectance mirror 151, a dichroic mirror 152, a condenser lens 153, and a collimator lens 154. The second laser light source unit 520 may include a titanium-sapphire laser device 121, a first wavelength conversion element 522, and a second wavelength conversion element 523. The second laser light source unit 520 may further include condenser lenses 555 and 562, collimator lenses 556 and 563, dichroic mirrors 557 and 561, high-reflectance mirrors 558 and 560, and a half-wave plate 559. The dichroic mirror 152 may reflect light with a wavelength λ₁ and transmit light with a wavelength λ_{4C}. The dichroic mirror 557 may reflect light with a wavelength λ_{4B} and transmit light with a wavelength λ_{4A}. The dichroic mirror 561 may reflect light with a wavelength λ_{4A} and transmit light with a wavelength λ_{4B}.

Laser light with a wavelength λ₁ emitted from the first laser light source unit 110 may be reflected from the high-reflectance mirror 151 and the dichroic mirror 152, and then, be incident on the VUV wavelength conversion element 130 via the condenser lens 153.

Laser light with a wavelength λ_{4A} emitted from the titanium-sapphire laser device 121 may be incident on the first wavelength conversion element 522 via the condenser lens 555 and subjected to wavelength conversion in the first wavelength conversion element 522 so as to emit laser light with an angular frequency 2ω and a wavelength λ_{4B}. Herein, laser light that is not subjected to wavelength conversion in the first wavelength conversion element 522 may be emitted from the first wavelength conversion element 522 as laser light with a wavelength λ_{4A}.

Thus, the laser light with a wavelength λ_{4A} and laser light with a wavelength λ_{4B} emitted from the first wavelength conversion element 522 may pass through the collimator lens 556, and then, the laser light with a wavelength λ_{4A} and the laser light with a wavelength λ_{4B} may be separated from each other by the dichroic mirror 557. Specifically, the dichroic mirror 557 may transmit the laser light with a wavelength λ_{4A} and reflect the laser light with a wavelength λ_{4B} to be separated from each other. Then, the laser light with a wavelength λ_{4A} transmitting through the dichroic mirror 557 may be reflected from the high-reflectance mirror 560 and the dichroic mirror 561 and be incident on the second wavelength conversion element 523 via the condenser lens 562. The laser light with a wavelength λ_{4B} reflecting from the dichroic mirror 557 may be reflected from the high-reflectance mirror 558, pass through the half-wave plate 559, transmit through the dichroic mirror 561, pass through the condenser lens 562, and be incident on the second wavelength conversion element 523.

The laser light with an angular frequency ω and a wavelength λ_{4A} and the laser light with an angular frequency 2ω and a wavelength λ_{4B} may be incident on the second wavelength conversion element 523 so that sum-frequency wavelength conversion may be conducted in the second wavelength conversion element 523 so as to emit laser light with an angular frequency 3ω and a wavelength λ_{4C}. The laser light with an angular frequency 3ω and a wavelength λ_{4C} emitted from the second wavelength conversion element 523 may transmit through the dichroic mirror 152 via the collimator lens 563, and then, be incident on the VUV wavelength conversion element 130 via the condenser lens 153. Light with a wavelength corresponding to a sum frequency of the incident laser light with a wavelength λ₁ and the laser light with a wavelength λ_{4C} may be emitted from the VUV wavelength conversion element 130 and pass through and exit from the collimator lens 154 as laser light from the solid-state light source.

Table 2 illustrates combinations of the first laser light source unit 110 and the titanium-sapphire laser device 121 in the second laser light source unit 520 that can be adopted in the fifth embodiment including the cases described above. Specifically, the case where Nd:YAG, Nd:YAP, or ND:YLF is used for the first laser light source unit 110 is illustrated therein.

TABLE 2

| | |
|---|---|
| | Second laser light |
| First laser light | source unit |
| source unit | Ti:Al₂O₃ |

| Gain medium | Wavelength λ₁ | ω | 3ω |
|---|---|---|---|
| Nd:YAG | 1112 nm | 703 nm | 234 nm |
| | 1116 nm | 702 nm | 234 nm |
| | 1123 nm | 701 nm | 234 nm |
| | 1319 nm | 680 nm | 227 nm |
| | 1338 nm | 679 nm | 226 nm |
| Nd:YAP | 1318 nm | 680 nm | 227 nm |
| | 1342 nm | 678 nm | 226 nm |
| Nd:YLF | 1313 nm | 681 nm | 227 nm |
| | 1321 nm | 680 nm | 227 nm |

The combination may be such that an Nd:YAG laser device that emits light with a wavelength λ1 of 1112 nm is used for the first laser light source unit 110 and a titanium-sapphire laser device 121 that emits light with an angular frequency ω and a wavelength of 703 nm is used for the second laser light source unit 520, so that an angular frequency 3ω and a wavelength of 234 nm are provided.

The combination may be such that an Nd:YAG laser device that emits light with a wavelength λ₁ of 1116 nm is used for the first laser light source unit 110 and a titanium-sapphire laser device 121 that emits light with an angular frequency in and a wavelength of 702 nm is used for the second laser light source unit 520, so that an angular frequency 3ω and a wavelength of 234 nm are provided.

The combination may be such that an Nd:YAG laser device that emits light with a wavelength λ₁ of 1123 nm is used for the first laser light source unit 110 and a titanium-sapphire laser device 121 that emits light with an angular frequency ω and a wavelength of 701 nm is used for the second laser light source unit 520, so that an angular frequency 3ω and a wavelength of 234 nm are provided.

The combination may be such that an Nd:YAG laser device that emits light with a wavelength λ₁ of 1319 nm is used for the first laser light source unit 110 and a titanium-sapphire laser device 121 that emits light with an angular frequency ω and a wavelength of 680 nm is used for the second laser light source unit 520, so that an angular frequency 3ω and a wavelength of 227 nm are provided.

The combination may be such that an Nd:YAG laser device that emits light with a wavelength λ₁ of 1338 nm is used for the first laser light source unit 110 and a titanium-sapphire laser device 121 that emits light with an angular frequency ω and a wavelength of 679 nm is used for the second laser light source unit 520, so that an angular frequency 3ω and a wavelength of 226 nm are provided.

The combination may be such that an Nd:YAP laser device that emits light with a wavelength λ₁ of 1318 nm is used for the first laser light source unit 110 and a titanium-sapphire laser device 121 that emits light with an angular frequency ω and a wavelength of 680 nm is used for the second laser light source unit 520, so that an angular frequency 3ω and a wavelength of 227 nm are provided.

The combination may be such that an Nd:YAP laser device that emits light with a wavelength λ₁ of 1342 nm is used for the first laser light source unit 110 and a titanium-sapphire laser device 121 that emits light with an angular frequency ω and a wavelength of 678 nm is used for the second laser light source unit 520, so that an angular frequency 3ω and a wavelength of 226 nm are provided.

The combination may be such that an Nd:YLF laser device that emits light with a wavelength λ₁ of 1313 nm is used for the first laser light source unit 110 and a titanium-sapphire laser device 121 that emits light with an angular frequency ω and a wavelength of 681 nm is used for the second laser light source unit 520, so that an angular frequency 3ω and a wavelength of 227 nm are provided.

The combination may be such that an Nd:YLF laser device that emits light with a wavelength λ₁ of 1321 nm is used for the first laser light source unit 110 and a titanium-sapphire laser device 121 that emits light with an angular frequency ω and a wavelength of 680 nm is used for the second laser light source unit 520, so that an angular frequency 3ω and a wavelength of 227 nm are provided.

### 4. LASER LIGHT TO BE INJECTED

4.1 A Beam Profile of Laser Light to be Injected

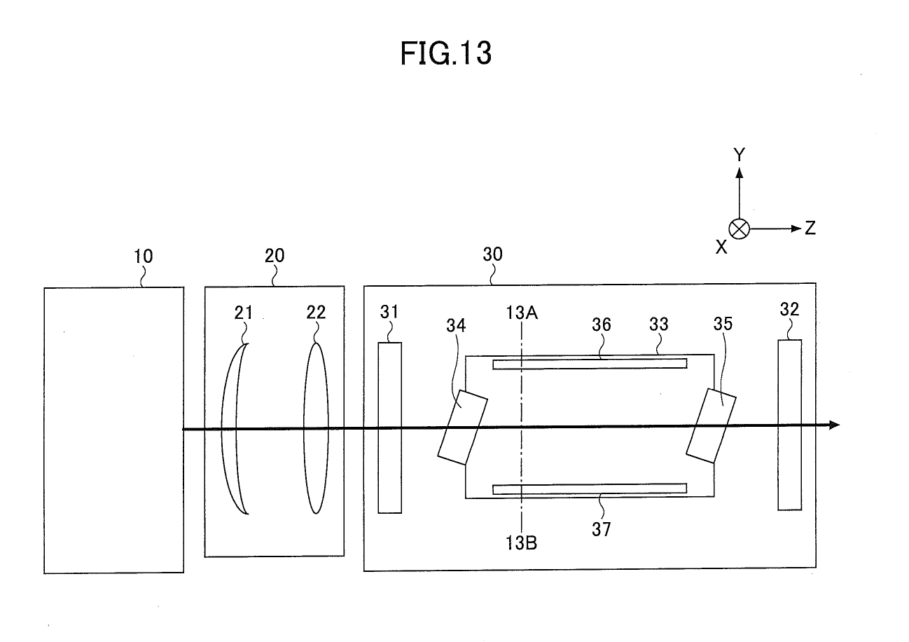

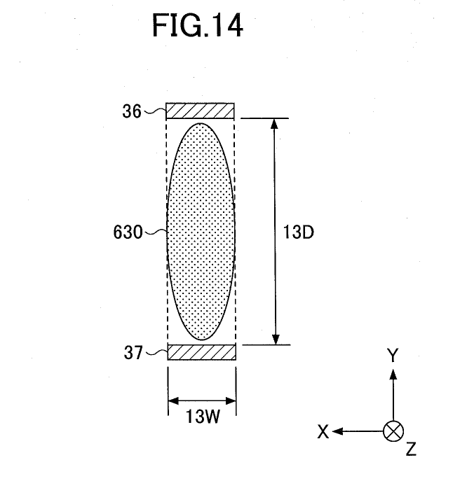

Next, a pulse shape to be injected into an amplifier will be described with reference to FIG. 13 and FIG. 14. FIG. 13 illustrates a structure similar to the laser apparatus illustrated in FIG. 1 and the laser apparatus in FIG. 13 may be provided with an electrode 36 and an electrode 37. As illustrated in FIG. 14, the electrode 36 and the electrode 37 may be provided in such a manner that a width in an X-direction is 13W and a distance between the electrode 36 and the electrode 37 in a Y-direction is 13D. FIG. 14 illustrates a beam profile of laser light passing between the electrode 36 and the electrode 37 in a Z-direction in the laser apparatus, that is, a cross-sectional shape of laser light (laser beam) cut along a dashed line 13A-13B in FIG. 13. An injection optical system 20, or the like, may be adjusted in such a manner that laser light 630 falls within an area between the electrode 36 and the electrode 37, that is, an area surrounded by a width of 13W in an X-direction and a distance 13D in a Y-direction, as illustrated in FIG. 14. Thereby, laser light may be able to be amplified more efficiently.

4.2 A Pulse Width of Laser Light to be Injected

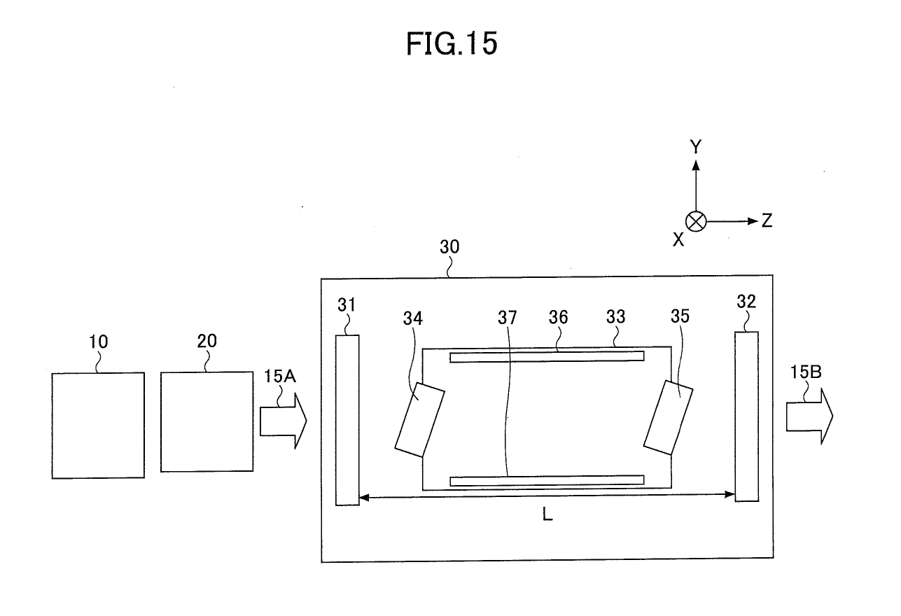

The pulse width of laser light to be injected into an amplifier will be described with reference to FIG. 15 to FIG. 21.

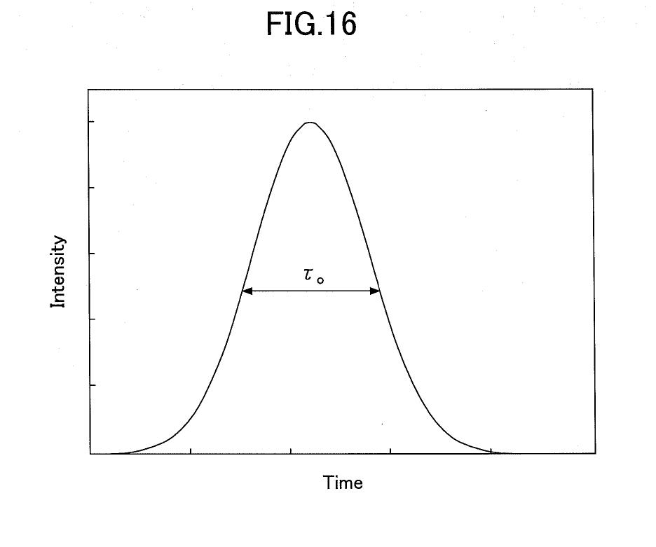

FIG. 15 is a diagram illustrating a pulse width of laser light to be injected, and simply illustrates a part of the laser apparatus illustrated in FIG. 13. Specifically, the laser apparatus may be such that a Fabry-Perot resonator is formed, wherein the distance between a partial reflection mirror 31 and an output coupler 32 in an amplifier 30, namely, a cavity length, is L. In such a Fabry-Perot resonator with a cavity length L, a round-trip propagation time T_{cavity} between the partial reflection mirror 31 and the output coupler 32 may be such that T_{cavity}=2 nL/C. Herein, n is a refractive index of space between the partial reflection mirror 31 and the output coupler 32 and C is a velocity of light. Hence, when the refractive index n is about 1 and the cavity length L is about 1 m, the round-trip propagation time T_{cavity} may be about 6 ns. The amplifier 30 illustrated in FIG. 15 may be an excimer amplifier, wherein the partial reflection mirror 31 may be, for example, a mirror with a reflectance of 90% and the output coupler 32 may be, for example, a mirror with a reflectance of 20%. In a case of a ring resonator, T_{cavity}=nLr/C may be provided wherein Lr is a circuit of an optical path length. A pulse waveform of laser light indicated by an arrow 15A in FIG. 15 is illustrated in FIG. 16. FIG. 16 illustrates time on a horizontal axis and intensity on a vertical axis and a pulse width τ₀ is a so-called half width.

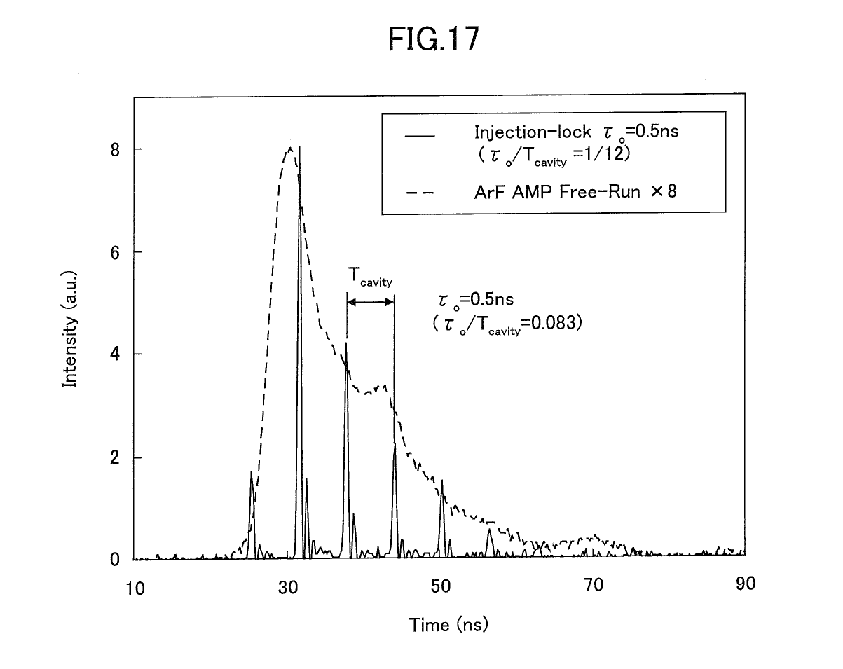

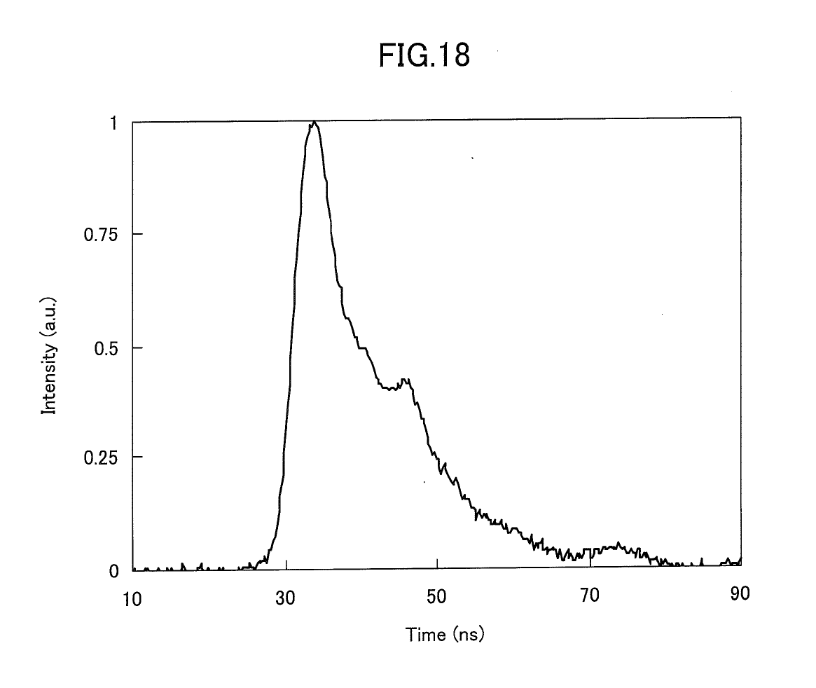

FIG. 17 illustrates a relationship between the intensity of laser light indicated by an arrow 15B in FIG. 15 and time in the case where a pulse width τ₀ is 0.5 ns and τ₀/T_{cavity}=0.083. As illustrated in FIG. 17, the intensity of laser light may be higher at a period of round-trip time T_{cavity}, wherein the peak intensity of laser light with a higher intensity may be extremely high and accordingly break an optical member, or the like. Hence, it is preferable to obtain an output with a peak intensity that is not so high. That is, when an ArF amplifier that is the resonator 30 oscillates without externally injecting laser light, a free-running output of the ArF amplifier can be obtained as illustrated in FIG. 18. A broken line illustrated in FIG. 17 indicates a free-running output of an ArF amplifier which is enlarged eight times.

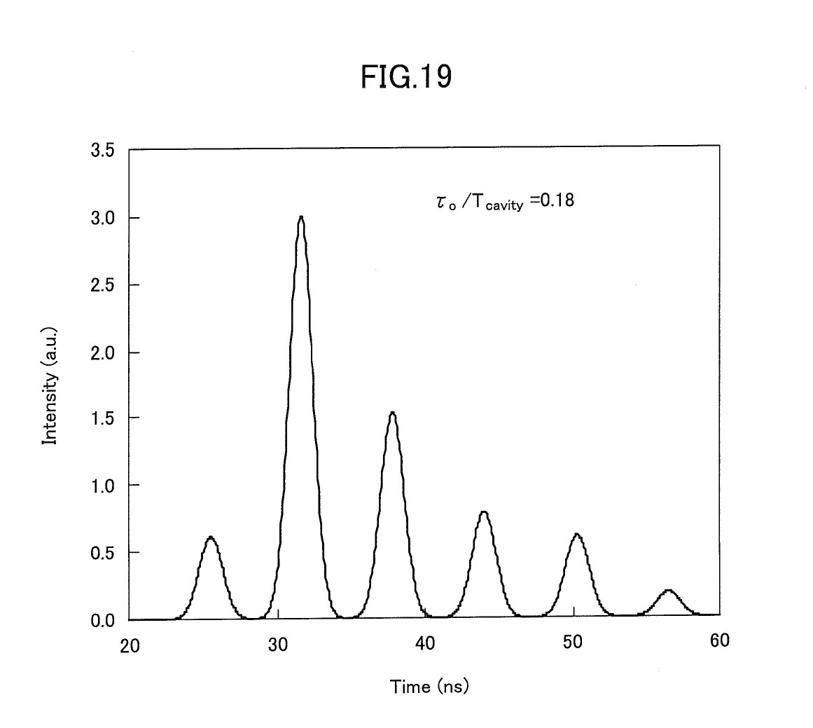

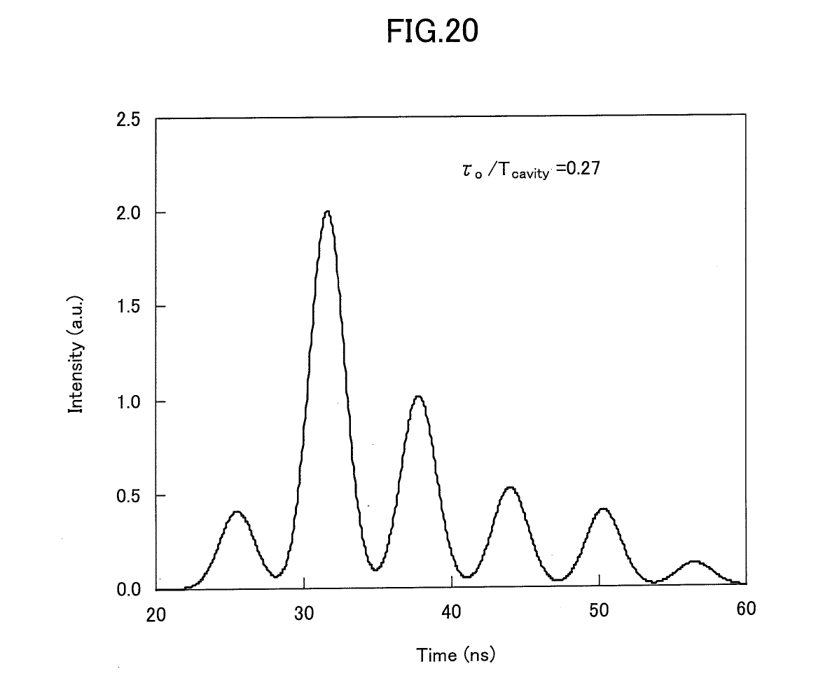

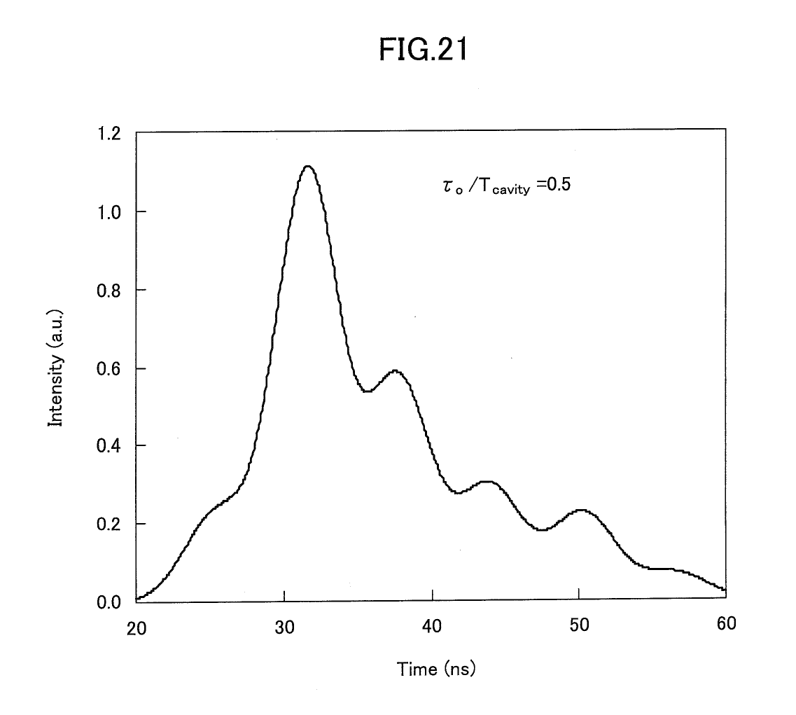

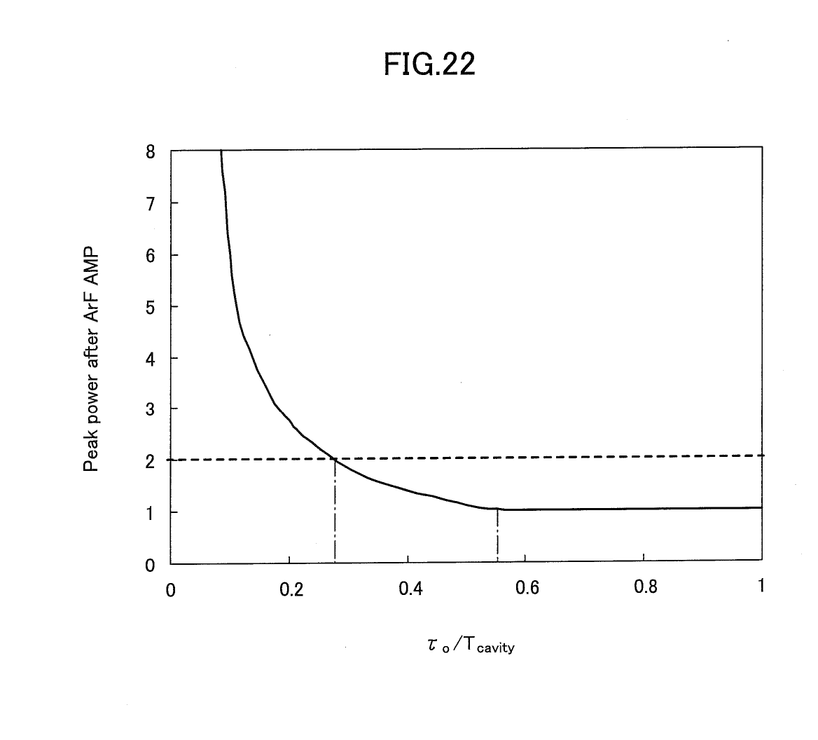

Then, the results of outputs in the case where a pulse width τ₀ was changed are illustrated in FIG. 19 to FIG. 22. FIG. 19 illustrates an output in the case of τ₀/T_{cavity}=0.18, FIG. 20 illustrates an output in the case of τ₀/T_{cavity}=0.27, and FIG. 21 illustrates an output in the case of τ₀/T_{cavity}=0.5. FIG. 22 illustrates a relationship between τ₀/T_{cavity} and a peak power, wherein it is preferable to set τ₀/T_{cavity} in such a manner that the peak power is 2 or less. Based on FIG. 19 to FIG. 22, the peak of an output in the case of τ₀/T_{cavity}=0.18 is about 3, the peak of an output in the case of τ₀/T_{cavity}=0.27 is about 2, and the peak of an output in the case of τ₀/T_{cavity}=0.5 is about 1.1. Hence, τ₀/T_{cavity}>0.27 is preferable in order that the peak power in FIG. 22 is 2 or less. As illustrated in FIG. 22, an output waveform in the case of τ₀/T_{cavity}>0.57 is generally identical to the free-running output of an ArF amplifier as illustrated in FIG. 18, and hence, the peak of an output is 1.

Meanwhile, it is generally understood that pulse waveform of laser light outputted by an injection-locking method is determined by the characteristics of an amplification unit. This is because an operation is usually conducted on the condition of τ₀>T_{cavity}, and hence, an operation satisfying the relation of τ₀>T_{cavity} is also conducted in an injection-locked laser device in which two excimer laser devices are used, because the cavity lengths of an oscillator and amplifier are generally identical. As described above, it first became clear in an experiment of the inventors of the present invention that an output in injection-locking was an isolated pulse sequence in the case of τ₀<<T_{cavity. If an output is thus an isolated pulse sequence, a peak power may increase and damage may be caused on an optical element, or the like, in the case where the laser apparatus is used as a light source for an exposure apparatus. Hence, it is preferable to increase a pulse width τ}₀ of injected laser light because the peak power of an output isolated pulse sequence can be reduced. Hence, it may be important to set a pulse width τ₀ of injected laser light to be less than a predetermined permissible value of a peak power. On the other hand, a smaller τ₀ is preferable, because a smaller τ₀ can suppress damage and improve efficiency in wavelength conversion. Hence, it is considered that a certain preferable range is present for a pulse width τ₀.

4.3 Adjustment of a Pulse Width of Laser Light to be Injected

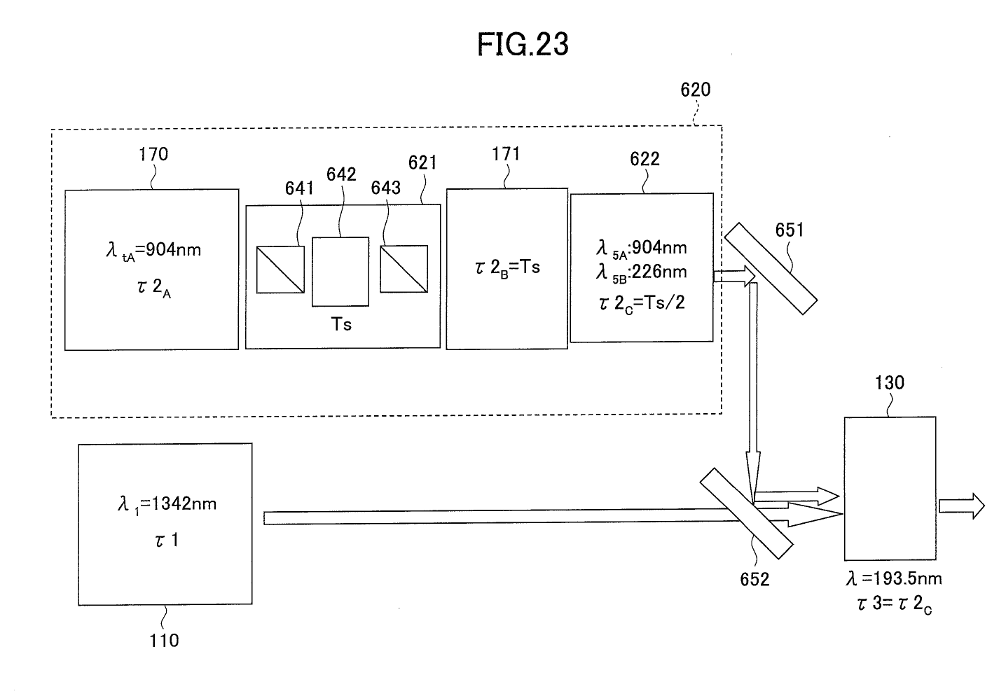

Meanwhile, the pulse width of laser light outputted from the solid-state light source 10 and injected into an amplifier may be a desired pulse width τ₀, and in that case, laser light outputted from the solid-state light source 10 can be used directly. However, when the pulse width of laser light outputted from the solid-state light source 10 is not a desired pulse width, or the like, a solid-state light source with the structure illustrated in FIG. 23 can be used for obtaining the desired pulse width of laser light.

As illustrated in FIG. 23, the solid-state light source may include the first laser light source unit 110, a second laser light source unit 620, the VUV wavelength conversion element 130, a high-reflectance mirror 651, a dichroic mirror 652, and the like.

The laser light source unit 110 may be an Nd:YVO₄ laser device and emit laser light with a wavelength of 1342 nm (λ₁) and a pulse width τ₁.

The second laser light source unit 620 may include the oscillator 170, an optical switch 621, the amplifier 171, a wavelength conversion unit 622, and the like. The oscillator 171 may be a titanium-sapphire oscillator composed of a titanium-sapphire laser device, and emit light with a wavelength of 904 nm (λ_{5A}) and a pulse width τ2λ_{A}. The optical switch 621 may include two polarizers 641 and 643, a Pockels cell 642, a driving power supply thereof, and the like, wherein Ts is a period of time in which a voltage applied to the Pockels cell is generally zero. The amplifier 171 may be a titanium-sapphire amplifier. The wavelength conversion unit 622 may be provided with a structure including a plurality of wavelength conversion elements and conduct wavelength conversion of light with a wavelength of 904 nm (λ_{5A}) into light with a wavelength of 226 nm (λ_{5B}). Specifically, for example, the first wavelength conversion elements 123 and 124 in the first embodiment, and the like, may be included.

The VUV wavelength conversion element 130 may be such that laser light with a wavelength of 1342 nm (λ₁) and laser light with a wavelength of 226 nm (λ_{5B}) are incident thereon to emit laser light with a wavelength of 193.5 nm (λ_{VUV}) corresponding to a sum-frequency of the light with wavelengths λ₁ and λ_{5B}. That is, the VUV wavelength conversion element 130 may emit light with a wavelength of 193.5 nm (λ_{VUV}) based on incident laser light with a wavelength of 1342 nm (λ₁) from the first laser light source unit 110 and laser light with a wavelength of 226 nm (λ_{5B}) from the second laser light source unit 620. The VUV wavelength conversion element 130 may be made of CLBO, BBO, or the like.

The dichroic mirror 652 may transmit light with a wavelength of 1342 nm (λ₁) and reflect light with a wavelength of 226 nm (λ_{5B}).

In the solid-state light source, laser light with a wavelength of 1342 nm (λ₁) and a pulse width τ1 may be emitted from the first laser light source unit 110, transmit through the dichroic mirror 652, and be incident on the VUV wavelength conversion element 130.

In the second laser light source unit 620, laser light with a wavelength of 904 nm (λ_{5A}) and a pulse width τ2_{A} may be emitted from the oscillator 170 and be incident on the optical switch 621. The optical switch 621 can pass incident laser light during a period of time Ts, and hence, laser light with a pulse width τ2_{B} that is Ts may exit from the optical switch 621 and be incident on the amplifier 171. In the amplifier 171, the incident laser light may be amplified and laser light with a pulse width τ2_{B} that is Ts may be emitted and be incident on the wavelength conversion unit 622. In the wavelength conversion unit 622, the incident laser light with a wavelength of 904 nm (λ_{5A}) and a pulse width τ2_{B} that is Ts is converted so as to emit laser light with a wavelength of 226 nm (λ_{5B}). Herein, the emitted laser light with a wavelength of 226 nm (λ_{5B}) may be converted by the wavelength conversion unit 622 to emit laser light with a pulse width τ2_{C} that is Ts/2. The laser light with a wavelength of 226 nm (λ_{5B}) and a pulse width τ2_{C} being Ts/2 that is emitted from the wavelength conversion unit 622 may be reflected from the high-reflectance mirror 651 and the dichroic mirror 652 and be incident on the VUV wavelength conversion element 130. The laser light with a wavelength of 226 nm (λ_{5B}) and a pulse width τλ_{C} being Ts/2 that is emitted from the wavelength conversion unit 622 may be laser light emitted from the second laser light source unit 620.

The VUV wavelength conversion element 130 may be such that laser light with a wavelength of 1342 nm (λ₁) and a pulse width τ1 and laser light with a wavelength of 226 nm (λ_{5B}) and a pulse width tλ_{C} being Ts/2 are incident thereon to be converted into and emit light with a wavelength of 193.5 nm corresponding to a sum-frequency thereof. Thus, the pulse width τ3 of light with a wavelength of 193.5 nm emitted from the VUV wavelength conversion element 130 may be equal to the pulse width τ2_{C}.

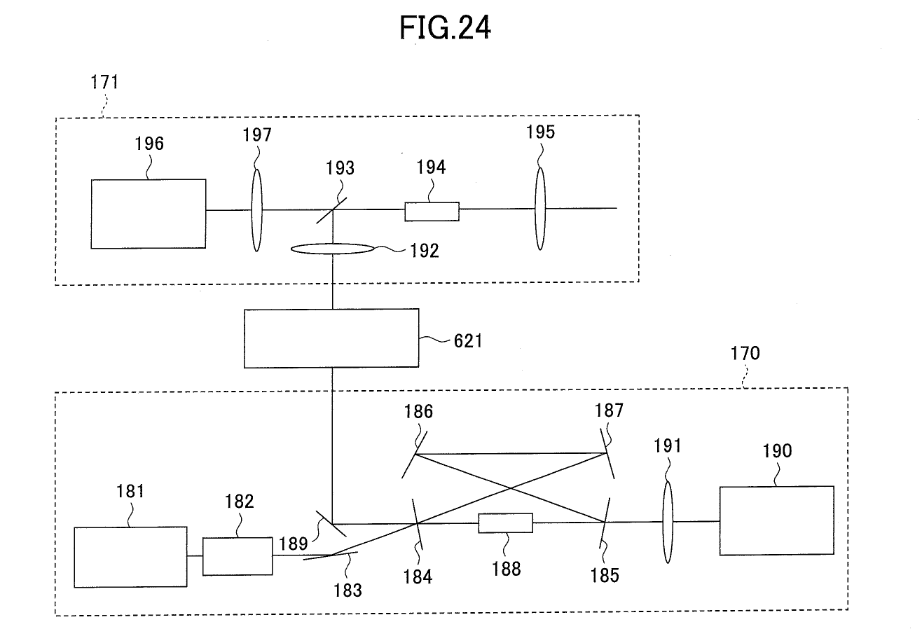

Next, the oscillator 170, the optical switch 621, and the amplifier 171 in the second laser light source unit 620 will be described with reference to FIG. 24. As illustrated in FIG. 24, a structure may be provided in such a manner that the optical switch 621 is provided between the oscillator 170 and the amplifier 171 in the titanium-sapphire laser device 121 illustrated in FIG. 4. The oscillator 170 may include the laser light source 181, the isolator 182, the high-reflectance mirrors 183, 186, 187, and 189, the output coupler 184, the dichroic mirror 185, the Ti:Al₂O₃ crystal 188, the Nd:YAG laser device 190, and the condenser lens 191. The amplifier 171 may include the condenser lens 192, the dichroic mirror 193, the Ti:Al₂O₃ crystal 194, the collimator lens 195, the Nd:YAG laser device 196, and the condenser lens 197. The dichroic mirrors 185 and 193 may reflect light with a wavelength of 904 nm and transmit light with a wavelength of 532 nm. The output coupler 184 may reflect a portion of incident light and transmit the rest thereof. The Nd:YAG laser devices 190 and 196 may emit light with a wavelength of 532 nm. The laser light source 181 may be a semiconductor laser device such as a DFB-LD and emit light with a wavelength of 904 nm.

Light with a wavelength of 904 nm emitted from the laser light source 181 may be incident on a Ti:Al₂O₃ ring-type amplifier via the isolator 182, the high-reflectance mirror 183, and the output coupler 184. The light with a wavelength of 904 nm entering from the output coupler 184 may be reflected from the output coupler 184, the high-reflectance mirrors 187 and 186, and the dichroic mirror 185. The Ti:Al₂O₃ crystal 188 may be provided on an optical path on which the light reflected from the output coupler 184, the high-reflectance mirrors 187 and 186, and the dichroic mirror 185 passes, and the laser light may pass through the Ti:Al₂O₃ crystal 188.

On the other hand, light with a wavelength of 532 nm emitted from the Nd:YAG laser device 190 may be incident on the Ti:Al₂O₃ crystal 188 via the condenser lens 191 and the dichroic mirror 185. Thereby, light with a wavelength of 904 nm may be amplified in the Ti:Al₂O₃ crystal 188 and the amplified laser light with a wavelength of 904 nm may exit from the output coupler 184. The laser light with a wavelength of 904 nm exiting from the output coupler 184 may be reflected from the high-reflectance mirror 189 and be incident on the optical switch 621.

The laser light with a wavelength of 904 nm incident on the optical switch 621 may be light with a pulse width that is a period of time during which the optical switch 621 is open, exit from the optical switch 621, and be incident on the amplifier 171.

The laser light with a wavelength of 904 nm incident on the amplifier 171 may pass through the condenser lens 192, then be reflected from the dichroic mirror 193, and be incident on the Ti:Al₂O₃ crystal 194. In the amplifier 171, light with a wavelength of 532 nm may be emitted from the Nd:YAG laser device 196 and pass through the condenser lens 197, and then transmit through the dichroic mirror 193 and be incident on the Ti:Al₂O₃ crystal 194. Thereby, the laser light with a wavelength of 904 nm may be amplified in the Ti:Al₂O₃ crystal 194 and pass though and exit from the collimator lens 195.

As a pulse with a high peak intensity is incident on a fiber laser amplifier, a self phase modulation may occur due to Kerr effect that is the third order nonlinear optical effect so as to broaden a spectral line. A solid-state laser device that forms a solid-state light source, or the like, may have a shorter propagation length so that a spectral change is hardly caused. Wavelength conversion at a wavelength of 193 nm may occur near an absorption edge, and hence, conversion efficiency may be reduced. Hence, it may be necessary to prepare oscillator light with a higher power to conduct wavelength conversion. A smaller line width (that is several dozen GHz or less) may be required for use in interference exposure.

In a fiber laser amplifier, spectral line may be broadened due to the nonlinearity thereof, and hence, a higher power and a narrower line width cannot be compatible. On the other hand, when a solid-state laser device (amplifier) is used, a higher power and a narrower line width can be compatible. Hence, the solid-state light source described above may be such that a high power unit is not a fiber but is composed of a solid-state laser.

The above-described embodiments and the modifications thereof are merely examples for implementing the present disclosure, and the present disclosure is not limited thereto. Making various modifications according to the specifications or the like is within the scope of the present disclosure, and other various embodiments are possible within the scope of the present disclosure. For example, the modifications illustrated for particular ones of the embodiments can be applied to other embodiments as well (including the other embodiments described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more”.

What is claimed is:

1. A laser apparatus, comprising:
a first laser light source configured to emit light with a first wavelength;
a second laser light source configured to emit light with a second wavelength; and
a wavelength conversion unit configured in such a manner that the light with the first wavelength and the light with the second wavelength are incident thereon to emit light with a wavelength of about 193 nm.

2. The laser apparatus as claimed in claim 1, wherein the second laser light source includes a titanium-sapphire laser device and a plurality of wavelength conversion elements, the second wavelength is one-fourth of a wavelength of light emitted from the titanium-sapphire laser device, and the wavelength of about 193 nm corresponds to a sum frequency of the light with the first wavelength and the light with the second wavelength.

3. The laser apparatus as claimed in claim 1, wherein the first laser light source includes a fiber laser amplifier, the second laser light source includes a fiber laser amplifier, the wavelength conversion unit includes a plurality of wavelength conversion elements, and the wavelength of about 193 nm corresponds to a sum frequency of light with a wavelength being one-fourth of the first wavelength and light with a wavelength being one-half of the second wavelength.

4. The laser apparatus as claimed in claim 1, wherein the second laser light source includes a titanium-sapphire laser device and a plurality of wavelength conversion elements, the second wavelength is one-third of a wavelength of light emitted from the titanium-sapphire laser device, and the wavelength of about 193 nm corresponds to a sum frequency of the light with a first wavelength and the light with a second wavelength.

5. A laser apparatus, comprising:
a laser light source including a fiber laser amplifier; and
a wavelength conversion unit including a plurality of wavelength conversion elements, the wavelength conversion unit being configured in such a manner that light emitted from the laser light source is incident thereon to emit light with a wavelength of about 193 nm being one-sixth of a wavelength of light emitted from the laser light source.

6. A laser apparatus comprising:
a resonator provided with an optical path length L; and
a master oscillator configured in such a manner that light with a wavelength of about 193 nm and a pulse width τ₀ is incident on the resonator as satisfying τ₀/T_{cavity}>0.27 with T_{cavity} denoting nL/C (n: a refractive index, C: velocity of light).

7. The laser apparatus as claimed in claim 6, wherein the resonator includes a Fabry-Perot resonator and the optical path length L is twice a cavity length of the Fabry-Perot resonator.

8. The laser apparatus as claimed in claim 6, wherein the resonator includes a ring resonator and the optical path length L is an optical path length of a circuit of the ring resonator.
